(19) United States
(12) Patent Application Publication
(10) Pub. No.: US 2014/0314141 A1
(43) Pub. Date: Oct. 23, 2014

(54) VIDEO ENCODING METHOD AND APPARATUS, AND VIDEO DECODING METHOD AND APPARATUS BASED ON SIGNALING OF SAMPLE ADAPTIVE OFFSET PARAMETERS

(71) Applicant: SAMSUNG ELECTRONICS CO., LTD., Suwon-si (KR)

(72) Inventors: Yong-seok CHOI, Seoul (KR); Jae-hwan JOO, Seoul (KR); Kyo-hyuk LEE, Yongin-si (KR)

(73) Assignee: SAMSUNG ELECTRONICS CO., LTD., Suwon-si (KR)

(21) Appl. No.: 14/256,664

(22) Filed: Apr. 18, 2014

Related U.S. Application Data
(60) Provisional application No. 61/813,757, filed on Apr. 19, 2013.

(30) Foreign Application Priority Data
Apr. 10, 2014 (KR) 10-2014-0043204

(51) Int. Cl. H04N 19/13; H04N 19/176; H04N 19/105

(52) U.S. Cl. CPC H04N 19/00121; H04N 19/00024; H04N 19/00278
USPC 375/240.02

(57) ABSTRACT

Signaling of a sample adaptive offset (SAO) parameter determined to minimize an error between an original image and a reconstructed image during video encoding and decoding operations. A video encoding method of signaling an SAO parameter includes, from among largest coding units (LCUs) of a video, obtaining prediction information before de-blocking of a currently encoded LCU is performed; predicting an SAO parameter of the currently encoded LCU based on the obtained prediction information; and performing entropy encoding on the predicted SAO parameter.

### RELATED APPLICATIONS

This application claims the benefit of U.S. Ser. No. 61/813,757, filed on Apr. 19, 2013, in the USPTO and Korean Patent Application No. 10-2014-0043204, filed on Apr. 10, 2014, in the Korean Intellectual Property Office, the disclosure of which are incorporated herein in their entirety by reference.

### BACKGROUND

1. Field

Exemplary embodiments relate to a video encoding method and apparatus and video decoding method and apparatus based on signaling of sample adaptive offset (SAO) parameters.

2. Description of the Related Art

As hardware for reproducing and storing high resolution or high quality video content is being developed and supplied, a need for a video codec for effectively encoding or decoding the high resolution or high quality video content is increasing. According to a related art video codec, a video is encoded according to a limited encoding method based on a coding unit having a predetermined size.

Image data of the space domain is transformed into coefficients of the frequency domain via frequency transformation. According to a video codec, an image is split into blocks having a predetermined size, discrete cosine transformation (DCT) is performed on each block, and frequency coefficients are encoded in block units, for rapid calculation of frequency transformation. Compared with image data of the space domain, coefficients of the frequency domain are easily compressed. In particular, since an image pixel value of the space domain is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

In particular, a method of adjusting a value of a reconstructed pixel as much as a SAO may be employed during an operation of encoding and decoding video so as to minimize an error between an original image and a reconstructed image.

### SUMMARY

Exemplary embodiments relate to predicting a sample adaptive offset (SAO) parameter based on data obtained from a reconstructed image of a current largest coding unit before performing de-blocking filtering by using temporal and spatial correlations within a moving image, thereby improving inefficiency of a circuit area and power consumption due to SAO encoding.

Exemplary embodiments relate to providing a method of determining a class of an edge offset based on directionality information obtained from a largest coding unit, thereby improving circuit implementation efficiency and power consumption for determining a SAO parameter.

Additional aspects will be set forth in part in the description which follows and, in part, will be apparent from the description, or may be learned by practice of the exemplary embodiments.

According to an exemplary embodiment, a video encoding method of signaling a sample adaptive offset (SAO) parameter includes: from among largest coding units (LCUs) of a video, obtaining prediction information before de-blocking of a currently encoded LCU is performed; predicting an SAO parameter of the currently encoded LCU based on the obtained prediction information; and performing entropy encoding on the predicted SAO parameter.

The predicting of the SAO parameter of the currently encoded LCU may be independent from the de-blocking of the currently encoded LCU.

The obtaining of the prediction information may include: obtaining an SAO parameter of another encoded coding unit before performing the de-blocking of the currently encoded LCU.

The prediction information may be an SAO parameter of a previously encoded LCU within a frame including the currently encoded LCU.

The prediction information may be an SAO parameter of an encoded LCU of a frame previous to a frame including the currently encoded LCU.

The obtaining of the prediction information may include: obtaining a reconstructed pixel value before performing the de-blocking of the currently encoded LCU, and wherein the predicting of the SAO parameter may include: predicting the SAO parameter of the currently encoded LCU based on the pixel value.

The prediction information may include at least one of residue data, a motion vector, and an intra mode that are obtained before the currently encoded LCU is reconstructed.

The video encoding method may further include: performing de-blocking on the currently encoded LCU; and determining an SAO parameter by using the currently encoded LCU on which the de-blocking is performed, wherein the SAO parameter determined with respect to the currently encoded LCU on which the de-blocking is performed is used to perform SAO prediction on a subsequently encoded LCU.

The video encoding method may be performed in a stage unit having a pipeline structure, and wherein the performing of the de-blocking and the performing of entropy encoding on the predicted SAO parameter are in parallel performed on the same pipeline stage.

According to an exemplary embodiment, a video encoding method of signaling an SAO parameter includes: from among LCUs of a video, obtaining directionality information of a currently encoded LCU; determining an edge offset parameter of the currently encoded LCU based on the obtained directionality information; and performing entropy encoding on the determined edge offset parameter.

The determining of the edge offset parameter may include: determining an edge class having directionality that is the same as or is orthogonal to a direction obtained based on the directionality information as the edge offset parameter.

The obtaining of the directionality information may include: obtaining directionality information of an edge of the currently encoded LCU by using a predetermined edge algorithm.

The obtaining of the directionality information may include: obtaining the directionality information by using intra mode information of the currently encoded LCU.

The obtaining of the directionality information may include: when intra modes of prediction units included in the currently encoded LCU are different from each other, calculating a histogram regarding the intra modes of the prediction units and obtaining the directionality information based on a number of occurrences of the intra modes from the histogram.

The obtaining of the directionality information may include: obtaining the directionality information based on a motion vector of the currently encoded LCU.

According to an exemplary embodiment, a video encoding apparatus for signaling an SAO parameter includes: a prediction information predictor for obtaining, from among LCUs of a video, prediction information before de-blocking of a currently encoded LCU is performed; an SAO parameter estimator for predicting an SAO parameter of the currently encoded LCU based on the obtained prediction information; and an encoder for performing entropy encoding on the predicted SAO parameter.

The prediction information predictor may obtain an SAO parameter of another encoded coding unit before the de-blocking of the currently encoded LCU is performed.

The prediction information may include at least one of a pixel value of a current LCU, residue data, a motion vector, and an intra mode that are reconstructed before the de-blocking of the currently encoded LCU is performed.

The video encoding apparatus may further include: a de-blocker for performing de-blocking on a currently encoded LCU; and an SAO determiner for determining an SAO parameter by using the currently encoded LCU on which de-blocking is performed, wherein the SAO parameter determined with respect to the currently encoded LCU on which de-blocking is performed is used to perform SAO prediction on a subsequently encoded LCU.

According to an exemplary embodiment, a video encoding apparatus for signaling an SAO parameter includes: a directionality information obtainer for obtaining, from among LCUs of video, directionality information of a currently encoded LCU; an edge offset parameter determiner for determining an edge offset parameter of the currently encoded LCU based on the obtained directionality information; and an encoder for performing entropy encoding on the determined edge offset parameter.

The edge offset parameter determiner may determine an edge class having directionality that is the same as or is orthogonal to a direction obtained based on the directionality information as the edge offset parameter.

The directionality information obtainer may obtain directionality information of an edge of the currently encoded LCU by using a predetermined edge algorithm.

The directionality information obtainer may obtain the directionality information by using intra mode information of the currently encoded LCU.

When intra modes of prediction units included in the currently encoded LCU are different from each other, the directionality information obtainer may calculate a histogram regarding the intra modes of the prediction units and obtain the directionality information based on a number of occurrences of the intra modes from the histogram.

The directionality information obtainer may obtain the directionality information based on a motion vector of the currently encoded LCU.

According to another aspect of one or more embodiments, there is provided a non-transitory computer-readable recording medium having recorded thereon a computer program for executing the video encoding method.

### BRIEF DESCRIPTION OF THE DRAWINGS

These and/or other aspects will become apparent and more readily appreciated from the following description of the embodiments, taken in conjunction with the accompanying drawings in which:

FIGS. 1A and 1B, respectively, are a block diagram of a sample adaptive offset (SAO) encoding apparatus and a flowchart of an SAO encoding method, according to one or more exemplary embodiments;

FIGS. 2A and 2B, respectively, are a block diagram of an SAO decoding apparatus and a flowchart of an SAO decoding method, according to one or more exemplary embodiments;

FIG. 3 is a block diagram of a video decoding apparatus according to another exemplary embodiment;

FIG. 4 is a table showing edge classes of edge types, according to one or more embodiments;

FIGS. 5A and 5B are a table and a graph showing categories of edge types, according to one or more exemplary embodiments;

FIGS. 6A through 6C are diagrams for explaining a method of encoding an SAO parameter, according to an exemplary embodiment;

FIG. 7 is a diagram for explaining a method of encoding an SAO parameter, according to an exemplary embodiment;

FIG. 8 illustrates an example of a method of encoding an SAO parameter, according to an exemplary embodiment;

FIG. 9 illustrates another example of a method of encoding an SAO parameter, according to an exemplary embodiment;

FIG. 10 illustrates another example of a method of encoding an SAO parameter, according to an exemplary embodiment;

FIGS. 11A and 11B, respectively, are a block diagram of an SAO encoding apparatus and a flowchart of a method of encoding an SAO parameter of an edge type, according to one or more exemplary embodiments;

FIG. 12 is diagram for explaining an example of a method of encoding an SAO parameter of an edge type, according to an exemplary embodiment;

FIG. 13 is diagram for explaining another example of a method of encoding an SAO parameter of an edge type, according to an exemplary embodiment;

FIG. 14 is diagram for explaining another example of a method of encoding an SAO parameter of an edge type, according to an exemplary embodiment;

FIG. 15 is a block diagram of a video encoding apparatus based on coding units according to a tree structure, according to one or more exemplary embodiments;

FIG. 16 is a block diagram of a video decoding apparatus based on coding units according to a tree structure, according to one or more exemplary embodiments;

FIG. 17 is a diagram for describing a concept of coding units according to one or more exemplary embodiments;

FIG. 18 is a block diagram of an image encoder based on coding units, according to one or more exemplary embodiments;

FIG. 19 is a block diagram of an image decoder based on coding units, according to one or more exemplary embodiments;

FIG. 20 is a diagram illustrating deeper coding units according to depths, and partitions, according to one or more exemplary embodiments;

FIG. 21 is a diagram for describing a relationship between a coding unit and transformation units, according to one or more exemplary embodiments;

FIG. 22 is a diagram for describing encoding information of coding units corresponding to a depth, according to one or more exemplary embodiments;

FIG. 23 is a diagram of deeper coding units according to depths, according to one or more exemplary embodiments;

FIGS. 24 through 26 are diagrams for describing a relationship between coding units, prediction units, and transformation units, according to one or more exemplary embodiments;

FIG. 27 is a diagram for describing a relationship between a coding unit, a prediction unit, and a transformation unit, according to encoding mode information of Table 1;

FIG. 28 is a diagram of a physical structure of a disc in which a program is stored, according to one or more exemplary embodiments;

FIG. 29 is a diagram of a disc drive for recording and reading a program by using a disc;

FIG. 30 is a diagram of an overall structure of a content supply system for providing a content distribution service;

FIGS. 31 and 32 are diagrams respectively of an external structure and an internal structure of a mobile phone to which a video encoding method and a video decoding method are applied, according to one or more embodiments;

FIG. 33 is a diagram of a digital broadcast system to which a communication system is applied, according to one or more exemplary embodiments; and

FIG. 34 is a diagram illustrating a network structure of a cloud computing system using a video encoding apparatus and a video decoding apparatus, according to one or more exemplary embodiments.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. Expressions such as “at least one of,” when preceding a list of elements, modify the entire list of elements and do not modify the individual elements of the list.

As used herein, terms such as “unit” and “module” indicate a unit for processing at least one function or operation, wherein the unit and the block may be embodied as hardware or software or may be embodied by combining hardware and software.

As used herein, the term “an embodiment” or “embodiments” refer to properties, structures, features, and the like, that are described in relation to an exemplary embodiment. Thus, expressions such as “according to an embodiment” do not always refer to the same exemplary embodiment.

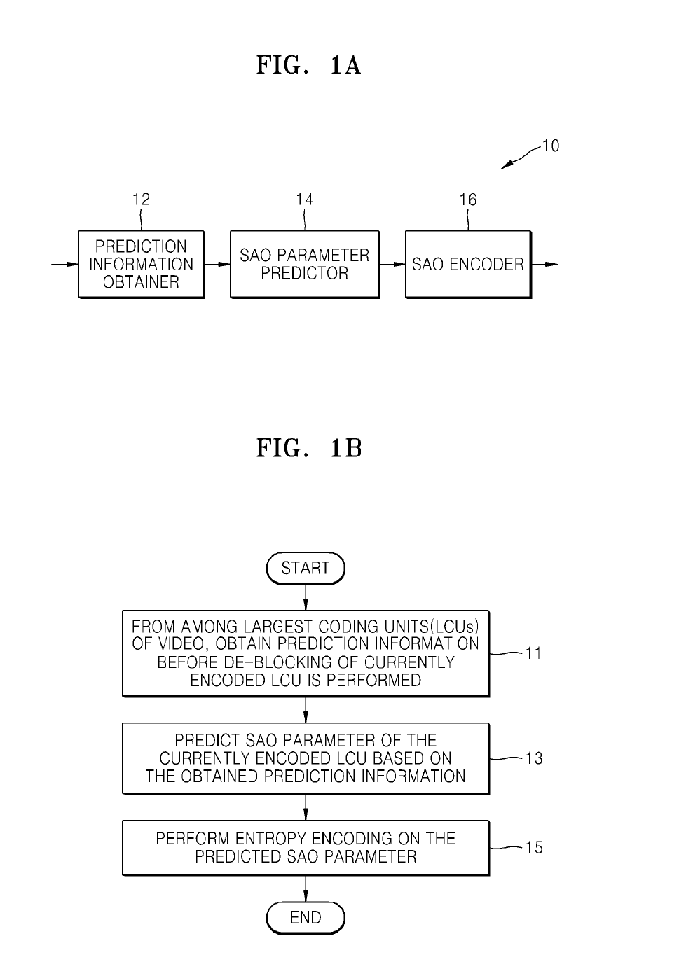

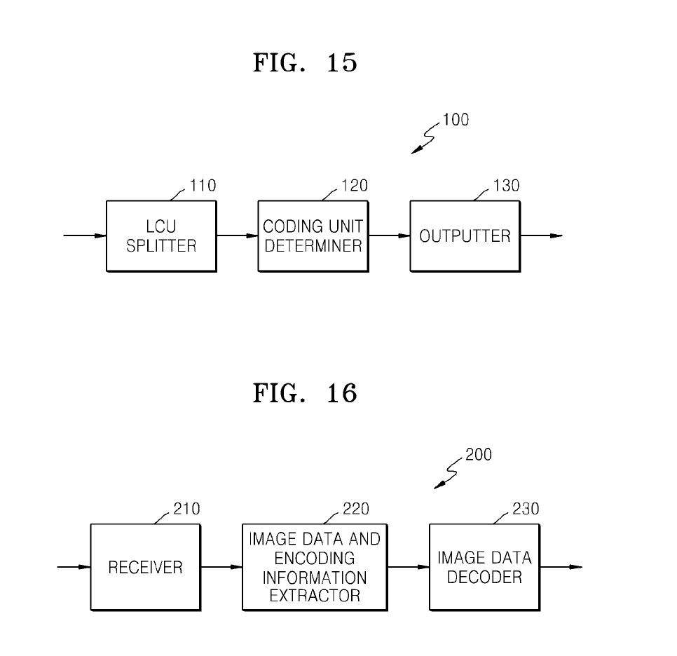

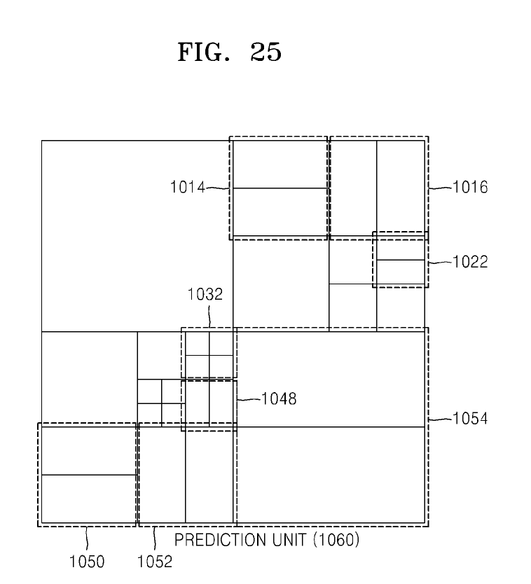

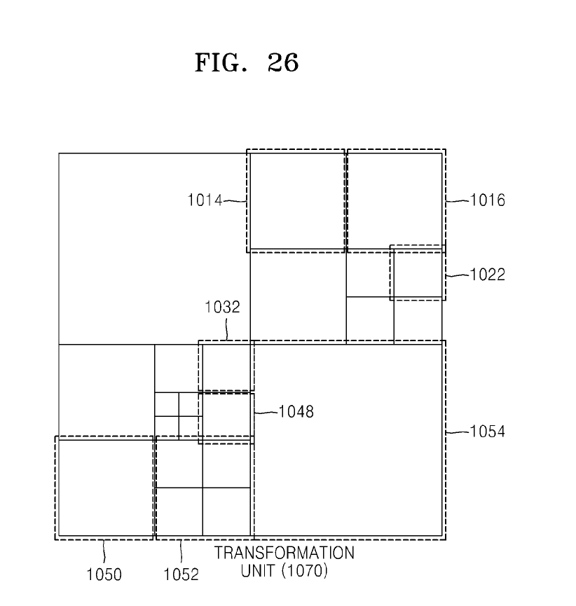

Hereinafter, a video encoding method and a video decoding method of signaling a sample adaptive offset (SAO) parameter according to one or more embodiments will be described with reference to FIGS. 1 through 10. A method of encoding a SAO parameter of an edge type according to an embodiment will be described with reference to FIGS. 11 through 14. A SAO operation based on pixel classification in video encoding operations and video decoding operations based on coding units having a tree structure, according to one or more embodiments, will be described with reference to FIGS. 15 through 34. Hereinafter, an ‘image’ may denote a still image or a moving image of a video, or a video itself.

The video encoding method and the video decoding method of signaling a SAO parameter according to one or more embodiments will now be described with reference to FIGS. 1 through 10.

Samples are signaled between a SAO encoding apparatus 10 and a SAO decoding apparatus 20. That is, the SAO encoding apparatus 10 may encode and transmit samples generated by video encoding in the form of a bitstream, and the SAO decoding apparatus 20 may parse and reconstruct the samples from the received bitstream.

In order to minimize an error between original pixels and reconstructed pixels by adjusting pixel values of the reconstructed pixels by an offset determined according to pixel classification, the SAO encoding apparatus 10 and the SAO decoding apparatus 20 according to an embodiment signal SAO parameters for the SAO adjustment. Between the SAO encoding apparatus 10 and the SAO decoding apparatus 20, offset values are encoded and transceived as the SAO parameters such that the offset values are decoded from the SAO parameters.

Thus, the SAO decoding apparatus 20 according to an embodiment may generate a reconstructed image having a minimized error between an original image and the reconstructed image by decoding a received bitstream, generating reconstructed pixels of each of image blocks, reconstructing offset values from the bitstream, and adjusting the reconstructed pixels by the offset values.

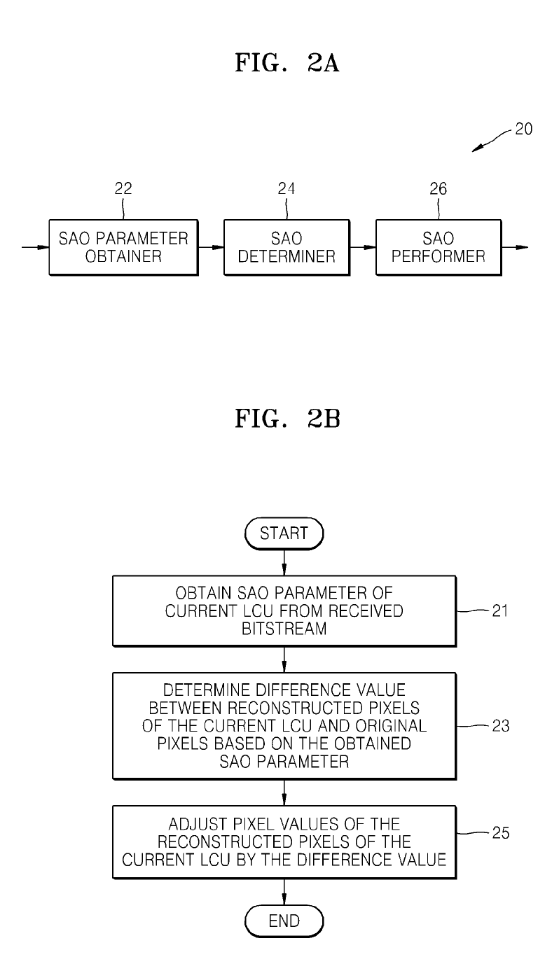

An operation of the SAO encoding apparatus 10 that performs a SAO operation will now be described with reference to FIGS. 1A and 1B. An operation of the SAO decoding apparatus 20 that performs the SAO operation will now be described with reference to FIGS. 2A and 2B.

FIGS. 1A and 1B, respectively, are a block diagram of the SAO encoding apparatus 10 and a flowchart of an SAO encoding method using prediction of a SAO parameter, according to one or more embodiments.

The SAO encoding apparatus 10 according to an embodiment includes a prediction information obtainer 12, a SAO parameter predictor 14, and an SAO encoder 16.

The SAO encoding apparatus 10 according to an embodiment receives an input of images such as slices of a video, splits each image into blocks, and encodes each block. A block may have a square shape, a rectangular shape, or an arbitrary geometrical shape, and is not limited to a data unit having a predetermined size. The block according to one or more embodiments may be a largest coding unit (LCU) or a CU among coding units according to a tree structure. Video encoding and decoding methods based on coding units according to a tree structure will be described below with reference to FIGS. 15 through 34.

The SAO encoding apparatus 10 according to an embodiment may split each input image into LCUs, and may output resultant data generated by performing prediction, transformation, and entropy encoding on samples of each LCU, as a bitstream. Samples of an LCU may be pixel value data of pixels included in the LCU.

The SAO encoding apparatus 10 according to an embodiment may individually encode LCUs of an image. The SAO encoding apparatus 10 may encode a current LCU based on coding units split from the current LCU and having a tree structure.

In order to encode the current LCU, the SAO encoding apparatus 10 may encode samples by performing intra prediction, inter prediction, transformation, and quantization on each of coding units included in the current LCU and having a tree structure.

Then, the SAO encoding apparatus 10 may reconstruct the encoded samples included in the current LCU by performing dequantization, inverse transformation, and inter prediction or intra compensation on each of the coding units having a tree structure so as to decode the coding units.

The SAO encoding apparatus 10 may also perform de-blocking on the reconstructed samples in the LCU so as to reduce image deterioration in block boundaries, and apply an SAO to the LCU on which de-blocking is performed so as to minimize an error between original pixels and reconstructed pixels.

However, if the SAO encoding apparatus 10 applies the SAO to the LCU, entropy encoding needs to be delayed until an SAO parameter is determined so as to signal the SAO parameter. In particular, since de-blocking needs to be performed so as to determine the SAO parameter, a hardware implementation load may greatly increase according to whether the SAO is applied.

In conclusion, when the SAO encoding apparatus 10 is implemented in hardware, an operation of performing entropy encoding for generating a bitstream needs to be postponed until an operation of determining the SAO parameter is completed. To this end, various types of information are buffered. Thus, a circuit size and power consumption may be inefficient.

Therefore, the SAO encoding apparatus 10 according to an embodiment may predict the SAO parameter based on prediction information obtained before de-blocking filtering on the current LCU is performed, and perform entropy encoding on the predicted SAO parameter, thereby improving inefficiency of a circuit area and power consumption due to SAO encoding.

The prediction information obtainer 12 according to an embodiment may prediction information before de-blocking is performed on a currently encoded LCU among LCUs of video.

The prediction information may include information that may be obtained before de-blocking is performed on the currently encoded LCU. For example, the prediction information may include residues of a currently encoded coding unit, a motion vector during inter prediction, an intra mode during intra prediction, etc.

The prediction information obtainer 12 according to an embodiment may predict an SAO parameter of the currently encoded LCU from a previously encoded coding unit. For example, the prediction information may be an SAO parameter of a previously encoded LCU within a frame including the currently encoded LCU. As another example, the prediction information may be an SAO parameter of an encoded LCU of a frame previous to the frame including the currently encoded LCU. That is, the prediction information obtainer 12 may use another LCU that may be temporally or spatially correlated with the current LCU to obtain the SAO parameter.

The SAO parameter predictor 14 according to an embodiment may predict the SAO parameter of the currently encoded LCU based on the obtained prediction information. In this regard, the prediction information is obtained before de-blocking is performed, and thus prediction of the SAO parameter may be independent from performing of de-blocking.

In more detail, the SAO parameter predictor 14 may predict an SAO type of the currently encoded LCU, an SAO class, and an offset value based on the obtained prediction information. In this regard, the SAO type may indicate an edge type or a band type according to a pixel value classification method of the current LCU, the SAO class may indicate an edge direction according to the edge type or a band range according to the band type, and the offset value may indicate a difference value between reconstructed pixels and original pixels included in the SAO class.

The SAO parameter predictor 14 according to an embodiment may predict the SAO parameter of the previously encoded LCU as the SAO parameter of the currently encoded LCU.

The SAO parameter predictor 14 according to an embodiment may predict the SAO parameter based on a pixel value reconstructed before de-blocking of the currently encoded coding unit is performed, the residues, the motion vector during inter prediction, the intra mode during intra prediction, etc.

For example, the SAO parameter predictor 14 may predict the SAO type of the currently encoded LCU as the edge type and an SAO class of the predicted edge type based on the motion vector during inter prediction, the intra mode during intra prediction, etc.

As another example, the prediction information obtainer 12 may obtain a reconstructed pixel value of a LCU on which de-blocking is not performed, and the SAO parameter predictor 14 may predict the SAO parameter from a pixel value on which de-blocking of the currently encoded LCU is skipped.

Meanwhile, the SAO encoding apparatus 10 according to an embodiment may include a de-blocking performer (not shown) that performs de-blocking on a reconstructed current LCU and an SAO determiner (not shown) that determines the SAO parameter by using the current LCU on which de-blocking is performed. This is because the SAO parameter of the current LCU determined by the SAO determiner (not shown) may be used to predict the SAO in a LCU that is to be encoded in the future. That is, the SAO encoding apparatus 10 may predict the SAO parameter by using the prediction information, and signal the predicted SAO parameter as the SAO parameter of the currently encoded LCU. The SAO encoding apparatus 10 may determine an SAO parameter of a LCU reconstructed after de-blocking is performed, and use the determined SAO parameter to predict the SAO in the LCU that is to be encoded in the future.

The SAO encoder 16 according to an embodiment may perform entropy encoding on the predicted SAO parameter.

According to entropy encoding methods, SAO parameters according to an embodiment may be classified into parameters to be encoded based on context-based entropy coding, and parameters to be encoded in a bypass mode.

The context-based entropy coding method may include a series of operations such as binarization for transforming symbols such as the SAO parameters into a bitstream, and context-based arithmetic encoding on the bitstream. Context adaptive binary arithmetic coding (CABAC) is broadly used an example of the context-based arithmetic encoding method. According to context-based arithmetic encoding and decoding, each bit of a symbol bitstream may be regarded as a bin of context, and each bit position may be mapped to a bin index. A length of the bitstream, i.e., a length of bins, may vary according to sizes of symbol values. For context-based arithmetic encoding and decoding, context-based probability modeling needs to be performed on symbols.

Context-based probability modeling needs to be performed on the assumption that a coding bit of a current symbol is probabilistically predicted based on previously encoded symbols. For context-based probability modeling, context of each bit position of a symbol bitstream, i.e., each bin index, needs to be newly updated. Here, probability modeling refers to a process of analyzing a probability that 0 or 1 is generated in each bin. A process of updating context by reflecting a result of analyzing a probability of each bit of the symbols of a new block to the context may be repeated in every block. If the above-described probability modeling is repeated, a probability model in which each bin is matched to a probability may be determined.

Accordingly, with reference to the context-based probability model, an operation of selecting and outputting a code corresponding to current context may be performed with respect to each bit of a binarized bitstream of current symbols, thereby performing context-based entropy encoding.

An operation of determining a context-based probability model of each bin of symbols for encoding based on context-based entropy coding requires large amounts of calculation and time. On the other hand, the entropy encoding in a bypass mode includes an entropy encoding operation using a probability model without considering context of symbols.

The method of encoding the SAO parameter predicted by the prediction information obtainer 12, the SAO parameter predictor 14, and the SAO encoder 16 according to an embodiment will now be described in more detail with reference to FIG. 1B below.

In operation 11, the prediction information obtainer 12 according to an embodiment may obtain prediction information before de-blocking of a currently encoded LCU among LCUs of video is performed.

The prediction information according to an embodiment may include information that may be obtained before de-blocking is performed on the currently encoded LCU. For example, the prediction information may include residues of a currently encoded coding unit, a motion vector during inter prediction, an intra mode during intra prediction, etc.

The prediction information obtainer 12 according to an embodiment may obtain an SAO parameter of a previously encoded coding unit among currently encoded LCUs before de-blocking is performed.

In operation 13, the SAO parameter predictor 14 according to an embodiment may predict an SAO parameter of the currently encoded LCU based on the obtained prediction information. For example, the SAO parameter predictor 14 may predict an SAO parameter of a previously encoded LCU as the SAO parameter of the currently encoded LCU.

As another example, the SAO parameter predictor 14 may predict the SAO parameter based on a pixel value reconstructed before de-blocking of the currently encoded coding unit is performed, the residues, the motion vector during inter prediction, the intra mode during intra prediction, etc.

In operation 15, the SAO encoder 16 according to an embodiment may perform entropy encoding on the predicted SAO parameter.

The SAO encoding apparatus 10 according to an embodiment may include a central processor (not shown) for collectively controlling the prediction information obtainer 12, the SAO parameter predictor 14, and the SAO encoder 16. Alternatively, the prediction information obtainer 12, the SAO parameter predictor 14, and the SAO encoder 16 may be driven by their individual processors (not shown) that cooperatively operate to control the SAO encoding apparatus 10. Alternatively, an external processor (not shown) outside the SAO encoding apparatus 10 according to an embodiment may control the prediction information obtainer 12, the SAO parameter predictor 14, and the SAO encoder 16.

The SAO encoding apparatus 10 according to an embodiment may include one or more data storages (not shown) for storing input and output data of the prediction information obtainer 12, the SAO parameter predictor 14, and the SAO encoder 16. The SAO encoding apparatus 10 may include a memory controller (not shown) for managing data input and output to and from the data storages.

In order to perform a video encoding operation including transformation and to output a result of the video encoding operation, the SAO encoding apparatus 10 according to an embodiment may operate in association with an internal or external video encoding processor. The internal video encoding processor of the SAO encoding apparatus 10 according to an embodiment may be an independent processor for performing a video encoding operation. Also, the SAO encoding apparatus 10, a central processing unit, or a graphic processing unit may include a video encoding processor module to perform a basic video encoding operation.

FIGS. 2A and 2B, respectively, are a block diagram of an SAO decoding apparatus 20 and a flowchart of an SAO decoding method, according to one or more embodiments.

The SAO decoding apparatus 20 according to an embodiment includes a SAO parameter obtainer 22, a SAO determiner 24, and a SAO performer 26.

The SAO decoding apparatus 20 according to an embodiment receives a bitstream including encoded data of a video. The SAO decoding apparatus 20 may parse encoded video samples from the received bitstream, may perform entropy decoding, dequantization, inverse transformation, prediction, and motion compensation on each image block to generate reconstructed pixels, and thus may generate a reconstructed image.

The SAO decoding apparatus 20 according to an embodiment may receive offset values indicating difference values between original pixels and reconstructed pixels, and may minimize an error between an original image and the reconstructed image. The video decoding apparatus 20 may receive encoded data of each LCU of the video, and may reconstruct the LCU based on coding units split from the LCU and having a tree structure. A method of reconstructing samples of a current LCU and adjusting offsets will now be described in detail with reference to FIG. 2B below.

In operation 21, the SAO parameter obtainer 22 may obtain an SAO parameter of the current LCU from a received bitstream. In this regard, the SAO parameter may include an SAO type of the current LCU, an offset value, and an SAO class.

In operation 23, the SAO determiner 24 may determine whether a pixel value classification method of the current LCU is an edge type or a band type, based on the SAO type determined by the SAO parameter obtainer 22. Based on the SAO type, an off type, the edge type, or the band type may be determined.

If the SAO type is the off type, it may be determined that an SAO operation is not applied to the current LCU. In this case, other SAO parameters of the current LCU do not need to be parsed.

The SAO determiner 24 may determine a band range according to an edge direction according to the edge type or a band range according to a band type of the current LCU, based on the SAO class determined by the SAO parameter obtainer 22.

The SAO determiner 24 may determine difference values between reconstructed pixels and original pixels included in the above-determined SAO class, based on the offset values determined by the SAO parameter obtainer 22.

In operation 25, the SAO performer 26 may adjust pixel values of samples reconstructed based on coding units split from the current LCU and having a tree structure, by the difference values determined by the SAO determiner 24.

In operation 23, the SAO determiner 24 may determine offset values corresponding to a predetermined number of categories, based on the SAO parameters. Each of the offset values may be greater than or equal to a preset minimum value and may be smaller than or equal to a preset maximum value.

For example, if SAO type information indicates the edge type, the SAO determiner 24 may determine an edge direction of the reconstructed pixels included in the current LCU as 0°, 90°, 45°, or 135°, based on the SAO class.

If the SAO type information indicates the band type in operation 23, the SAO determiner 24 may determine positions of bands to which pixel values of the reconstructed pixels belong, based on the SAO class.

If the SAO type information indicates the band type in operation 23, the SAO determiner 24 may determine whether an offset value is 0 or not, based on zero value information of the offset value. If the offset value is determined as 0 based on the zero value information, information of the offset value other than the zero value information is not reconstructed.

If the offset value is not determined as 0 based on the zero value information, the SAO determiner 24 may determine whether the offset value is a positive number or a negative number, based on sign information of the offset value, which is followed by the zero value information. The SAO determiner 24 may finally determine an offset value by reconstructing a remainder of the offset value, which is followed by the sign information.

If the SAO type information indicates the edge type in operation 23 and if the offset value is not determined as 0 based on the zero value information of the offset value, the SAO determiner 24 may finally determine the offset value by reconstructing the remainder of the offset value, which is followed by the zero value information.

Meanwhile, the SAO decoding apparatus 20 according to an embodiment may include a central processor (not shown) for collectively controlling the SAO parameter obtainer 22, the SAO determiner 24, and the SAO performer 26. Alternatively, the SAO parameter obtainer 22, the SAO determiner 24, and the SAO performer 26 may be driven by their individual processors (not shown) that cooperatively operate to control the video decoding apparatus 20. Alternatively, an external processor (not shown) outside the SAO decoding apparatus 20 according to an embodiment may control the SAO parameter obtainer 22, the SAO determiner 24, and the SAO performer 26.

The SAO decoding apparatus 20 according to an embodiment may include one or more data storages (not shown) for storing input and output data of the SAO parameter obtainer 22, the SAO determiner 24, and the SAO performer 26. The SAO decoding apparatus 20 according to an embodiment may include a memory controller (not shown) for managing data input and output to and from the data storages.

In order to perform a video decoding operation to reconstruct a video, the SAO decoding apparatus 20 according to an embodiment may operate in association with an internal or external video decoding processor. The internal video decoding processor of the SAO decoding apparatus 20 according to an embodiment may be an independent processor for performing a basic video decoding operation. Also, the SAO decoding apparatus 20, a central processing unit, or a graphic processing unit may include a video decoding processor module to perform a basic video decoding operation.

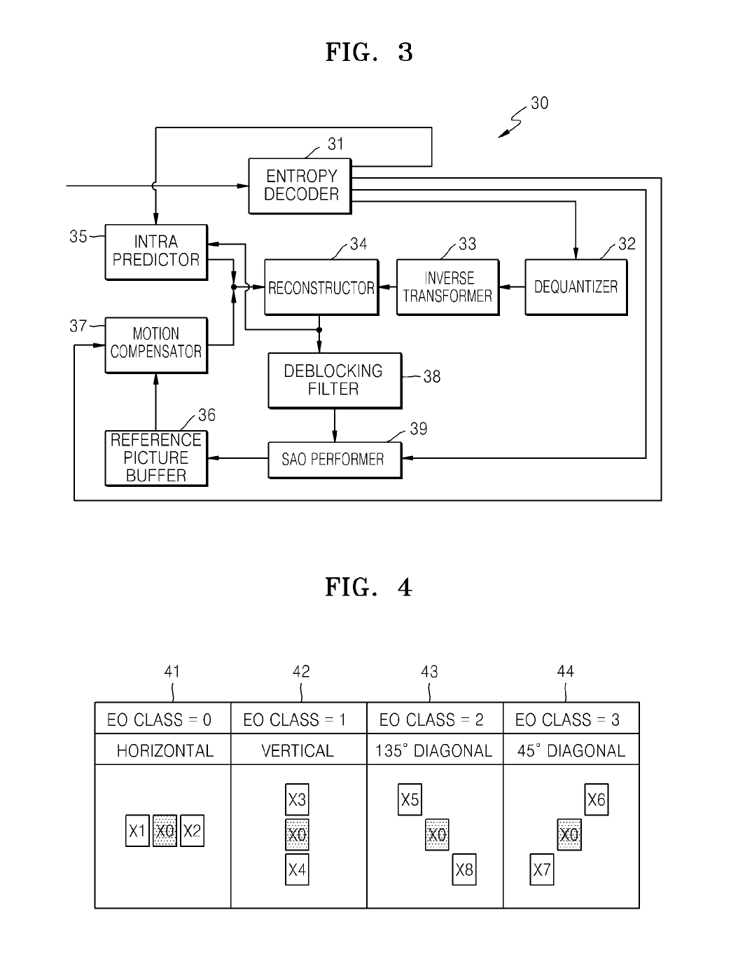

Video decoding operations using SAO operations will now be described in detail with reference to FIG. 3. FIG. 3 is a block diagram of a video decoding apparatus 30 according to one or more embodiments.

The video decoding apparatus 30 includes an entropy decoder 31, a dequantizer 32, an inverse transformer 33, a reconstructor 34, an intra predictor 35, a reference picture buffer 36, a motion compensator 37, a deblocking filter 38, and a SAO performer 39.

The video decoding apparatus 30 may receive a bitstream including encoded video data. The entropy decoder 31 may parse intra mode information, inter mode information, SAO information, and residues from the bitstream.

The residues extracted by the entropy decoder 31 may be quantized transformation coefficients. Accordingly, the dequantizer 32 may perform dequantization on the residues to reconstruct transformation coefficients, and the inverse transformer 33 may perform inverse transformation on the reconstructed reconstructed coefficients to reconstruct residual values of the space domain.

In order to predict and reconstruct the residual values of the space domain, intra prediction or motion compensation may be performed.

If the intra mode information is extracted by the entropy decoder 31, the intra predictor 35 may determine reference samples to be referred to reconstruct current samples from among samples spatially adjacent to the current samples, by using the intra mode information. The reference samples may be selected from among samples previously reconstructed by the reconstructor 34. The reconstructor 34 may reconstruct the current samples by using the reference samples determined based on the intra mode information and the residual values reconstructed by the inverse transformer 33.

If the inter mode information is extracted by the entropy decoder 31, the motion compensator 37 may determine a reference picture to be referred to reconstruct current samples of a current picture from among pictures reconstructed previously to the current picture, by using the inter mode information. The inter mode information may include motion vectors, reference indices, etc. By using the reference indices, from among pictures reconstructed previously to the current picture and stored in the reference picture buffer 36, a reference picture to be used to perform motion compensation on the current samples may be determined. By using the motion vectors, a reference block of the reference picture to be used to perform motion compensation on a current block may be determined. The reconstructor 34 may reconstruct the current samples by using the reference block determined based on the inter mode information and the residual values reconstructed by the inverse transformer 33.

The reconstructor 34 may reconstruct samples and may output reconstructed pixels. The reconstructor 34 may generate reconstructed pixels of each of LCUs based on coding units having a tree structure.

The deblocking filter 38 may perform filtering for reducing a blocking phenomenon of pixels disposed at edge regions of the LCU or each of the coding units having a tree structure.

Also, the SAO performer 39 may adjust offsets of reconstructed pixels of each LCU according to a SAO operation. The SAO performer 39 may determine a SAO type, a SAO class, and offset values of a current LCU based on the SAO information extracted by the entropy decoder 31.

An operation of extracting the SAO information by the entropy decoder 31 may correspond to an operation of the SAO parameter extractor 22 of the video decoding apparatus 20, and operations of the SAO performer 39 may correspond to operations of the SAO determiner 24 and the SAO performer 26 of the video decoding apparatus 20.

The SAO performer 39 may determine signs and difference values of the offset values with respect to the reconstructed pixels of the current LCU based on the offset values determined from the SAO information. The SAO performer 39 may reduce errors between the reconstructed pixels and original pixels by increasing or reducing pixel values of the reconstructed pixels by the difference values determined based on the offset values.

A picture including the reconstructed pixels offset-adjusted by the SAO performer 39 may be stored in the reference picture buffer 36. Thus, by using a reference picture having minimized errors between reconstructed samples and original pixels according to a SAO operation, motion compensation may be performed on a next picture.

According to the SAO operations, based on difference values between reconstructed pixels and original pixels, an offset of a pixel group including the reconstructed pixels may be determined. For the SAO operations, embodiments for classifying reconstructed pixels into pixel groups will now be described in detail.

According to SAO operations, pixels may be classified (i) based on an edge type of reconstructed pixels, or (ii) a band type of reconstructed pixels. Whether pixels are classified based on an edge type or a band type may be defined by using a SAO type.

An embodiment of classifying pixels based on an edge type according to SAO operations will now be described in detail.

When edge-type offsets of a current LCU are determined, an edge class of each of reconstructed pixels included in the current LCU may be determined. That is, by comparing pixel values of current reconstructed pixels and adjacent pixels, an edge class of the current reconstructed pixels may be defined. An example of determining an edge class will now be described with reference to FIG. 4.

FIG. 4 is a table showing edge classes of edge types, according to one or more embodiments.

Indices 0, 1, 2, and 3 may be sequentially allocated to edge classes 41, 42, 43, and 44. If an edge type frequently occurs, a small index may be allocated to the edge type.

An edge class may indicate a direction of 1-dimentional edges formed between a current reconstructed pixel X0 and two adjacent pixels. The edge class 41 having the index 0 indicates a case when edges are formed between the current reconstructed pixel X0 and two horizontally adjacent pixels X1 and X2. The edge class 42 having the index 1 indicates a case when edges are formed between the current reconstructed pixel X0 and two vertically adjacent pixels X3 and X4. The edge class 43 having the index 2 indicates a case when edges are formed between the current reconstructed pixel X0 and two 135°-diagonally adjacent pixels X5 and X8. The edge class 44 having the index 3 indicates a case when edges are formed between the current reconstructed pixel X0 and two 45°-diagonally adjacent pixels X6 and X7.

Accordingly, by analyzing edge directions of reconstructed pixels included in a current LCU and thus determining a strong edge direction in the current LCU, an edge class of the current LCU may be determined.

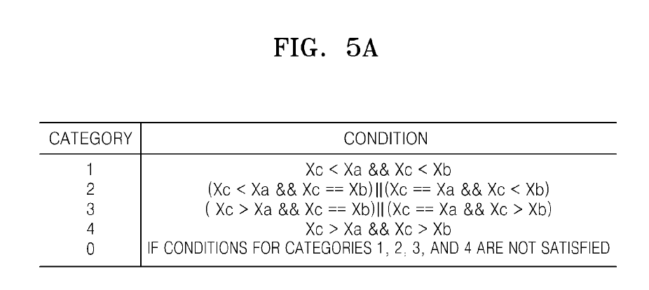

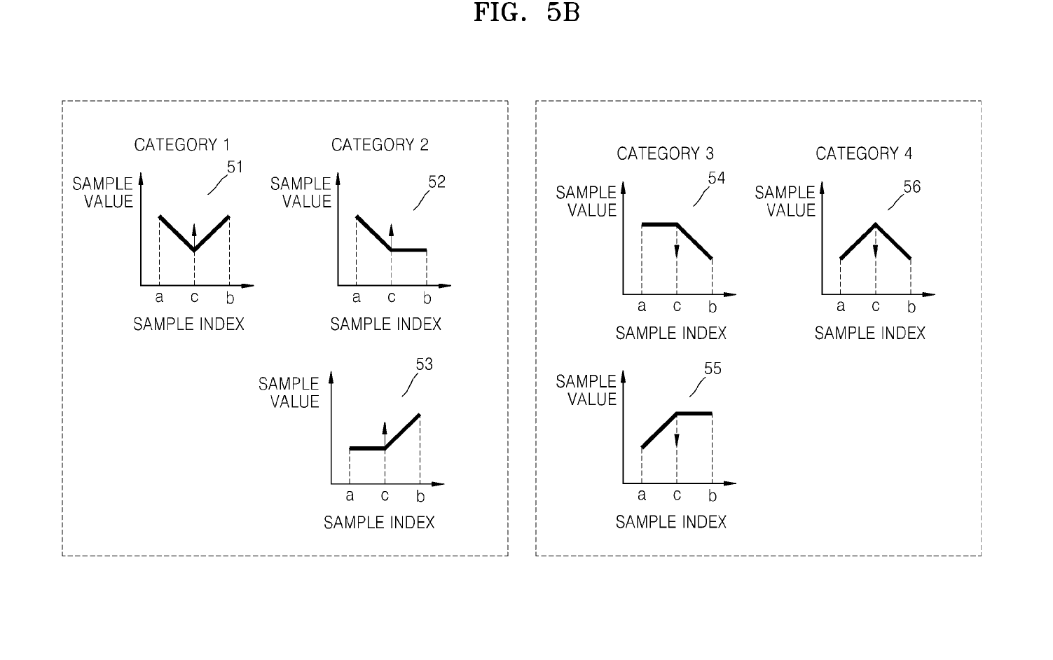

With respect to each edge class, categories may be classified according to an edge shape of a current pixel. An example of categories according to edge shapes will now be described with reference to FIGS. 5A and 5B.

FIGS. 5A and 5B are a table and a graph showing categories of edge types, according to one or more embodiments.

An edge category indicates whether a current pixel corresponds to a lowest point of a concave edge, a pixel disposed at a curved corner around a lowest point of a concave edge, a highest point of a convex edge, or a pixel disposed at a curved corner around a highest point of a convex edge.

FIG. 5A exemplarily shows conditions for determining categories of edges. FIG. 5B exemplarily shows edge shapes between a reconstructed pixel and adjacent pixels and their pixel values c, a, and b.

C indicates an index of a current reconstructed pixel, and a and b indicate indices of adjacent pixels at two sides of the current reconstructed pixel according to an edge direction. Xa, Xb, and Xc respectively indicate pixel values of reconstructed pixels having the indices a, b, and c. In FIG. 5B, an x axis indicate indices of the current reconstructed pixel and the adjacent pixels at two sides of the current reconstructed pixel, and a y axis indicate pixel values of samples.

Category 1 indicates a case when a current sample corresponds to a lowest point of a concave edge, i.e., a local valley. As shown in graph 51 (Xc<Xa && Xc<Xb), if the current reconstructed pixel c between the adjacent pixels a and b corresponds to a lowest point of a concave edge, the current reconstructed pixel may be classified as the category 1.

Category 2 indicates a case when a current sample is disposed at a curved corner around a lowest point of a concave edge, i.e., a concave corner. As shown in graph 52 (Xc<Xa && Xc==Xb), if the current reconstructed pixel c between the adjacent pixels a and b is disposed at an end point of a downward curve of a concave edge or, as shown in graph 53 (Xc==Xa && Xc<Xb), if the current reconstructed pixel c is disposed at a start position of an upward curve of a concave edge, the current reconstructed pixel may be classified as the category 2.

Category 3 indicates a case when a current sample is disposed at a curved corner around a highest point of a convex edge, i.e., a convex corner. As shown in graph 54 (Xc>Xb && Xc==Xa), if the current reconstructed pixel c between the adjacent pixels a and b is disposed at a start position of a downward curve of a convex edge or, as shown in graph 55 (Xc==Xb && Xc>Xa), if the current reconstructed pixel c is disposed at an end point of an upward curve of a convex edge, the current reconstructed pixel may be classified as the category 3.

Category 4 indicates a case when a current sample corresponds to a highest point of a convex edge, i.e., a local peak. As shown in graph 56 (Xc>Xa && Xc>Xb), if the current reconstructed pixel c between the adjacent pixels a and b corresponds to a highest point of a convex edge, the current reconstructed pixel may be classified as the category 1.

If the current reconstructed pixel does not satisfy any of the conditions of the categories 1, 2, 3, and 4, the current reconstructed pixel does not corresponds to an edge and thus is classified as category 0, and an offset of category 0 does not need to be encoded.

According to one or more embodiments, with respect to reconstructed pixels corresponding to the same category, an average value of difference values between the reconstructed pixels and original pixels may be determined as an offset of a current category. Also, offsets of all categories may be determined.

The concave edges of the categories 1 and 2 may be smoothed if reconstructed pixel values are adjusted by using positive offset values, and may be sharpened due to negative offset values. The convex edges of the categories 3 and 4 may be smoothed due to negative offset values and may be sharpened due to positive offset values.

The SAO encoding apparatus 10 according to an embodiment may not allow the sharpening effect of edges. Here, the concave edges of the categories 1 and 2 need positive offset values, and the convex edges of the categories 3 and 4 need negative offset values. In this case, if a category of an edge is known, a sign of an offset value may be determined. Accordingly, the SAO encoding apparatus 10 may not transmit the sign of the offset value and may transmit only an absolute value of the offset value. Also, the SAO decoding apparatus 20 may not receive the sign of the offset value and may receive only an absolute value of the offset value.

Accordingly, the SAO encoding apparatus 10 may encode and transmit offset values according to categories of a current edge class, and the SAO decoding apparatus 20 may adjust reconstructed pixels of the categories by the received offset values.

For example, if an offset value of an edge type is determined as 0, the video encoding apparatus 10 may transmit only zero value information as the offset value.

For example, if an offset value of an edge type is not 0, the SAO encoding apparatus 10 may transmit zero value information and an absolute value as the offset value. A sign of the offset value does not need to be transmitted.

The SAO decoding apparatus 20 reads the zero value information from the received offset value, and may read the absolute value of the offset value if the offset value is not 0. The sign of the offset value may be predicted according to an edge category based on an edge shape between a reconstructed pixel and adjacent pixels.

Accordingly, the SAO encoding apparatus 10 according to an embodiment may classify pixels according to edge directions and edge shapes, may determine an average error value between pixels having the same characteristics as an offset value, and may determine offset values according to categories. The video encoding apparatus 10 may encode and transmit SAO type information indicating an edge type, SAO class information indicating an edge direction, and the offset values.

The SAO decoding apparatus 20 according to an embodiment may receive the SAO type information, the SAO class information, and the offset values, and may determine an edge direction according to the SAO type information and the SAO class information. The SAO decoding apparatus 20 may determine an offset value of reconstructed pixels of a category corresponding to an edge shape according to the edge direction, and may adjust pixel values of the reconstructed pixels by the offset value, thereby minimizing an error between an original image and a reconstructed image.

An embodiment of classifying pixels based on a band type according to SAO operations will now be described in detail.

According to one or more embodiments, each of pixel values of reconstructed pixels may belong to one of a plurality of bands. For example, the pixel values may have a total range from a minimum value Min of 0 to a maximum value Max of 2̂(p−1) according to p-bit sampling. If the total range (Min, Max) of the pixel values is divided into K intervals, each interval of the pixel values is referred to as a band. If Bₖ indicates a maximum value of a kth band, bands [B₀, B₁−1], [B₁, B₂−1], [B₂, B₃−1], . . . , and [Bₖ−1, Bₖ] may be divided. If a pixel value of a current reconstructed pixel Rec(x,y) belongs to the band [Bₖ−1, Bₖ], a current band may be determined as k. The bands may be uniformly or non-uniformly divided.

For example, if pixel values are classified into equal 8-bit pixel bands, the pixel values may be divided into 32 bands. In more detail, they may be classified into bands [0, 7], [8, 15], . . . , [240, 247], and [248, 255].

From among a plurality of bands classified according to a band type, a band to which each of pixel values of reconstructed pixels belongs may be determined. Also, an offset value indicating an average of errors between original pixels and reconstructed pixels in each band may be determined.

Accordingly, the SAO encoding apparatus 10 and the SAO decoding apparatus 20 may encode and transceive an offset corresponding to each of bands classified according to a current band type, and may adjust reconstructed pixels by the offset.

Accordingly, with respect to a band type, the SAO encoding apparatus 10 and the SAO decoding apparatus 20 according to an embodiment may classify reconstructed pixels according to bands to which their pixel values belong, may determine an offset as an average of error values of reconstructed pixels that belong to the same band, and may adjust the reconstructed pixels by the offset, thereby minimizing an error between an original image and a reconstructed image.

When an offset according to a band type is determined, the SAO encoding apparatus 10 and the SAO decoding apparatus 20 according to an embodiment may classify reconstructed pixels into categories according to a band position. For example, if the total range of the pixel values is divided into K bands, categories may be indexed according to a band index k indicating a kth band. The number of categories may be determined to correspond to the number of bands.

However, in order to reduce amount of data, the SAO encoding apparatus 10 and the SAO decoding apparatus 20 may restrict the number of categories used to determine offsets according to SAO operations. For example, a predetermined number of bands that are continuous from a band having a predetermined start position in a direction in which a band index is increased may be allocated as categories, and only an offset of each category may be determined.

For example, if a band having an index of 12 is determined as a start band, four bands from the start band, i.e., bands having indices of 12, 13, 14, and 15 may be allocated as categories 1, 2, 3, and 4. Accordingly, an average error between reconstructed pixels and original pixels included in a band having the index of 12 may be determined as an offset of category 1. Likewise, an average error between reconstructed pixels and original pixels included in a band having the index of 13 may be determined as an offset of category 2, an average error between reconstructed pixels and original pixels included in a band having the index of 14 may be determined as an offset of category 3, and an average error between reconstructed pixels and original pixels included in a band having the index of 15 may be determined as an offset of category 4.

In this case, information regarding a band range start position, i.e., a left band position, is required to determine positions of bands allocated as categories. Accordingly, the SAO encoding apparatus 10 according to an embodiment may encode and transmit the information about the start band position as the SAO class. The SAO encoding apparatus 10 may encode and transmit a SAO type indicating a band type, a SAO class, and offset values according to categories.

The SAO decoding apparatus 20 according to an embodiment may receive the SAO type, the SAO class, and the offset values according to the categories. If the received SAO type is a band type, the SAO decoding apparatus 20 may read a start band position from the SAO class. The SAO decoding apparatus 20 may determine a band to which reconstructed pixels belong, from among four bands from the start band, may determine an offset value allocated to a current band from among the offset values according to the categories, and may adjust pixel values of the reconstructed pixels by the offset value.

Hereinabove, an edge type and a band type are introduced as SAO types, and a SAO class and a category according to the SAO type are described in detail.

SAO parameters encoded and transceived by the SAO encoding apparatus 10 and the SAO decoding apparatus 20 will now be described in detail.

The SAO encoding apparatus 10 and the SAO decoding apparatus 20 according to an embodiment may determine a SAO type according to a pixel classification method of reconstructed pixels of each LCU.

The SAO type may be determined according to image characteristics of each block. For example, with respect to an LCU including a vertical edge, a horizontal edge, and a diagonal edge, in order to change edge values, offset values may be determined by classifying pixel values according to an edge type. With respect to an LCU not including an edge region, offset values may be determined according to band classification. Accordingly, the SAO encoding apparatus 10 and the SAO decoding apparatus 20 may signal the SAO type with respect to each of LCUs.

The SAO encoding apparatus 10 and the SAO decoding apparatus 20 according to an embodiment may determine SAO parameters with respect to each LCU. That is, SAO types of reconstructed pixels of an LCU may be determined, the reconstructed pixels of the LCU may be classified into categories, and offset values may be determined according to the categories.

From among the reconstructed pixels included in the LCU, the SAO encoding apparatus 10 may determine an average error of reconstructed pixels classified into the same category, as an offset value. An offset value of each category may be determined.

According to one or more embodiments, the SAO parameters may include a SAO type, offset values, and a SAO class. The SAO encoding apparatus 10 and the SAO decoding apparatus 20 may transceive the SAO parameters determined with respect to each LCU.

From among SAO parameters of an LCU, the SAO encoding apparatus 10 according to an embodiment may encode and transmit the SAO type and the offset values. If the SAO type is an edge type, the SAO encoding apparatus 10 according to an embodiment may further transmit a SAO class indicating an edge direction, which is followed by the SAO type and the offset values according to categories. If the SAO type is a band type, the SAO encoding apparatus 10 according to an embodiment may further transmit a SAO class indicating a start band position, which is followed by the SAO type and the offset values according to categories. If the SAO type is the edge type, the SAO class may be classified as edge class information. If the SAO type is the band type, the SAO class may be classified as band position information.

The SAO decoding apparatus 20 according to an embodiment may receive the SAO parameters of each LCU, which includes the SAO type, the offset values, and the SAO class. Also, the SAO decoding apparatus 20 according to an embodiment may select an offset value of a category to which each reconstructed pixel belongs, from among the offset values according to categories, and may adjust the reconstructed pixel by the selected offset value.

An embodiment of signaling offset values from among SAO parameters will now be described.

In order to transmit the offset values, the SAO encoding apparatus 10 according to an embodiment may further transmit sign information and a remainder offset absolute value.

If the offset absolute value is 0, the sign information or the remainder does not need to be encoded. However, if the offset absolute value is not 0, the sign information and the remainder may be further transmitted.

However, as described above, with respect to the edge type, since the offset value may be predicted as a positive number or a negative number according to a category, the sign information does not need to be transmitted.

According to one or more embodiments, an offset value Off-set may be previously restricted within a range from a minimum value MinOffSet and a maximum value MaxOffSet before the offset value is determined (MinOffSet≦Off-Set≦MaxOffSet).

For example, with respect to an edge type, offset values of reconstructed pixels of categories 1 and 2 may be determined within a range from a minimum value of 0 to a maximum value of 7. With respect to the edge type, offset values of reconstructed pixels of categories 3 and 4 may be determined within a range from a minimum value of −7 to a maximum value of 0.

For example, with respect to a band type, offset values of reconstructed pixels of all categories may be determined within a range from a minimum value of −7 to a maximum value of 7.

In order to reduce transmission bits of an offset value, a remainder may be restricted to a p-bit value instead of a negative number. In this case, the remainder may be greater than or equal to 0 and may be less than or equal to a difference value between the maximum value and the minimum value (0≦Remainder≦MaxOffSet−MinOffSet+1≦2̂p). If the SAO encoding apparatus 10 transmits the remainder and the SAO decoding apparatus 20 knows at least one of the maximum value and the minimum value of the offset value, an original offset value may be reconstructed by using only the received remainder.

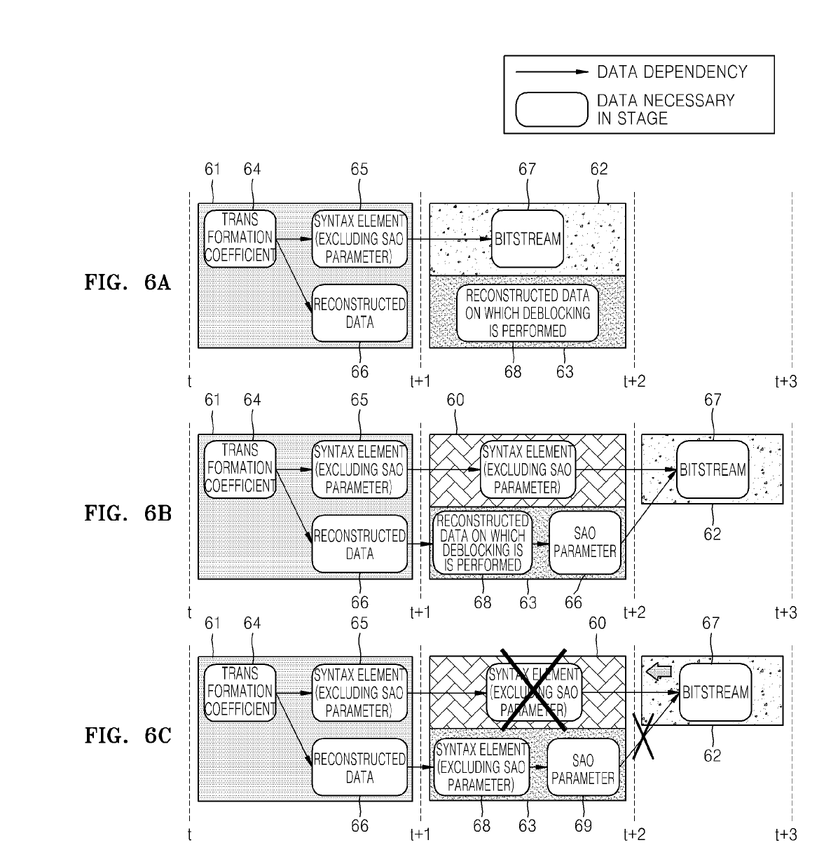

FIGS. 6A through 6C are diagrams for explaining a method of encoding an SAO parameter, according to an embodiment. FIGS. 6A through 6C illustrate examples of implementing a video encoding method according to an embodiment in hardware and processing the video encoding method in a pipe line shape. In this regard, a method of implementing the video encoding method in hardware may include a very large scale integration (VLSI) implementation method or a multi-core implementation method but is not necessarily limited thereto.

Referring to FIGS. 6A through 6C, 7, and 10, pipeline stages classified as t, t+1, and t+2, and encoding stages indicated by reference numerals 61, 62, and 63 are illustrated. In this regard, the pipeline stages classified as t, t+1, and t+2 indicate time-sequentially processed operations when an encoding apparatus is implemented in hardware, and the encoding stages indicated by reference numerals 61, 62, and 63 indicate predetermined operations of an encoding method according to an embodiment. Arrows indicate data dependency. Blocks indicate necessary data of each stage.

FIG. 6A illustrates a video encoding method when an SAO is not applied. FIG. 6B illustrates a video encoding method when the SAO is applied.

Referring to FIG. 6A, the stage 61 may obtain reconstructed data 66 of a currently encoded LCU by performing dequantization and inverse transformation on a transformation coefficient 64. Before the stage 61, intra and inter prediction, generation of residues, transformation and quantization, etc. may be further performed. It is assumed that such processing is performed in advance with respect to FIGS. 6A, 6B, and 6C for convenience of description. Meanwhile, the stage 61 may obtain a syntax element 65 before the reconstructed data 66 is obtained. In this regard, the syntax element 65 is necessary when a decoding apparatus receives a bitstream later, and does not include an SAO parameter. Then, the stage 62 may generate a bitstream 67 by performing entropy encoding. The stage 63 may perform de-blocking on the reconstructed data 66 and generate the reconstructed data 68 on which de-blocking is performed.

The encoding method of FIG. 6A relates to a case where the SAO is not applied, and has no data dependency on a resultant value between the stages 62 and 63. Thus, when the encoding method is implemented in hardware, the stages 62 and 63 may be simultaneously performed in the same pipeline stage (t+1 and t+2).

On the other hand, the encoding method of FIG. 6B relates to a case where the SAO is applied, and thus the stage 63 that performs de-blocking and the stage 62 that performs entropy encoding may not be simultaneously performed in the same pipeline stage, and processing of the pipeline stages may be delayed until the stage 63 that performs de-blocking obtains an SAO parameter 69. That is, the encoding method of FIG. 6B further performs an operation of determining the SAO parameter 69 with respect to the reconstructed data 68 on which de-blocking is performed, and thus processing of the stage 62 that is dependent on the SAO parameter 69 is delayed. Thus, an additional stage 60 that transfers the syntax element 65 for performing entropy encoding to the stage 62 and storage space are necessary, which may lead to an increase in a circuit size and power consumption.

Therefore, the SAO encoding apparatus 10 according to an embodiment may predict an SAO parameter based on data obtained before de-blocking filtering of a current LCU, by using temporal and spatial correlations within a moving image, thereby improving a circuit area and power consumption due to SAO encoding. When the SAO encoding apparatus 10 is implemented in hardware, data dependency between de-blocking and determination of an SAO may be removed during entropy encoding, thereby reducing an amount of buffered data and power efficiency.

Referring to FIG. 6C, when the stage 62 performs entropy encoding, the SAO encoding apparatus 10 according to an embodiment may not use the SAO parameter 69 determined based on the reconstructed data 68 on which de-blocking is performed.

Therefore, the operation of performing de-blocking on the current LCU and the operation of encoding the SAO parameter may be performed in parallel in the same pipeline stage (for example, t1˜t2). That is, there may be a reduction by one pipeline stage in FIG. 6C compared to FIG. 6B.

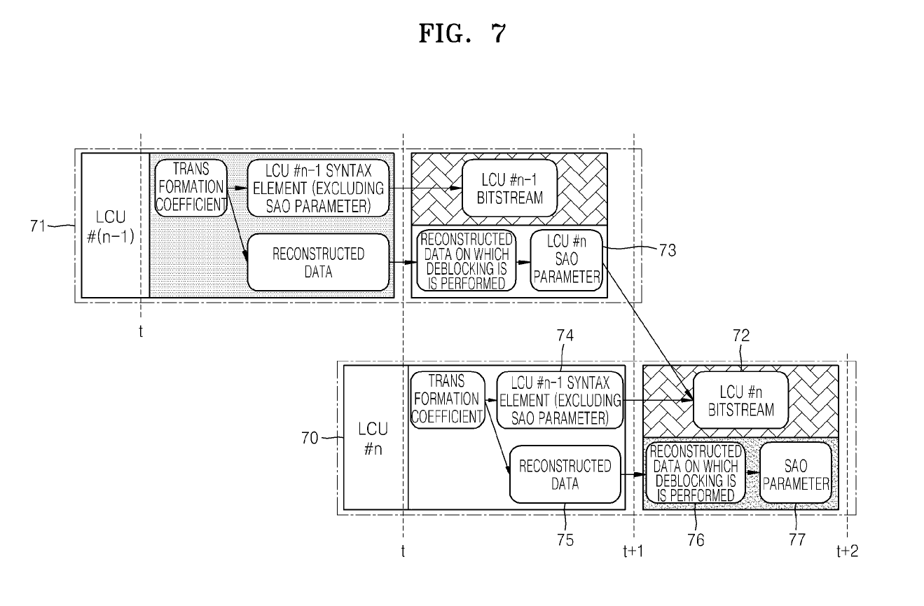

A method of removing dependency of the SAO parameter 69 determined based on the reconstructed data 68 on which de-blocking is performed will be described in more detail with reference to FIGS. 7 through 10 below.

FIG. 7 is a diagram for explaining a method of encoding an SAO parameter, according to an embodiment.

Referring to FIG. 7, the SAO encoding apparatus 10 according to an embodiment may predict and encode an SAO parameter 73 of a currently encoded LCU 70 from a previously encoded LCU 71. For example, the SAO encoding apparatus 10 may encode the previously determined SAO parameter 73 as an SAO parameter of the currently encoded LCU 70, may not wait until de-blocking is completed, and may generate a bitstream 72 with respect to the SAO parameter and the LCU #n−1 syntax 74.

Furthermore, the SAO encoding apparatus 10 may perform de-blocking on reconstructed data 75 of the current LCU 70, and may determine an SAO parameter 77 from reconstructed data 76 on which de-blocking is performed. The SAO parameter 77 determined in the current LCU 70 may be used as an SAO parameter of a LCU that is to be next encoded.

Although the current LCU 70 and the previously encoded LCU 71 are encoded in pipeline stages immediately before entropy encoding in FIG. 7, the exemplary embodiments are not limited thereto. SAO parameters of temporally and spatially previously encoded LCUs #n−1, n−2, n−3, . . . of currently encoded LCUs may be used.

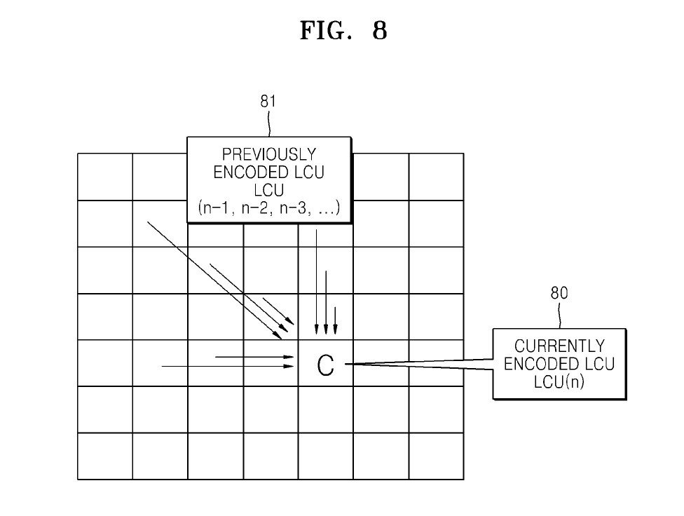

FIG. 8 illustrates an example of a method of encoding an SAO parameter, according to an embodiment.

Referring to FIG. 8, a currently encoded LCU 80 may perform entropy encoding on an SAO of the currently encoded LCU 80 by using an SAO parameter of a previously encoded LCU 81, within the same frame.

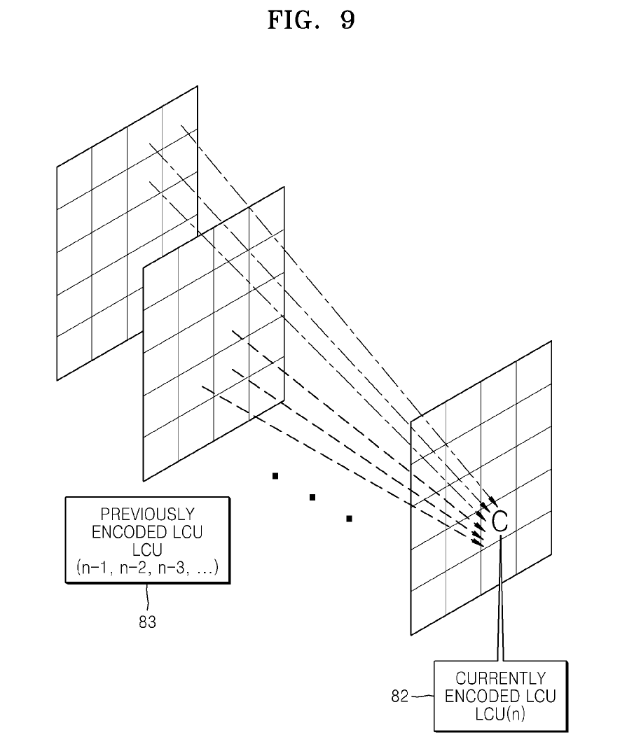

FIG. 9 illustrates another example of a method of encoding an SAO parameter, according to an embodiment.

Referring to FIG. 9, a currently encoded LCU 82 may perform entropy encoding on an SAO of the currently encoded LCU 82 by using an SAO parameter of a LCU 83 encoded in a frame previous to a frame including a current LCU.

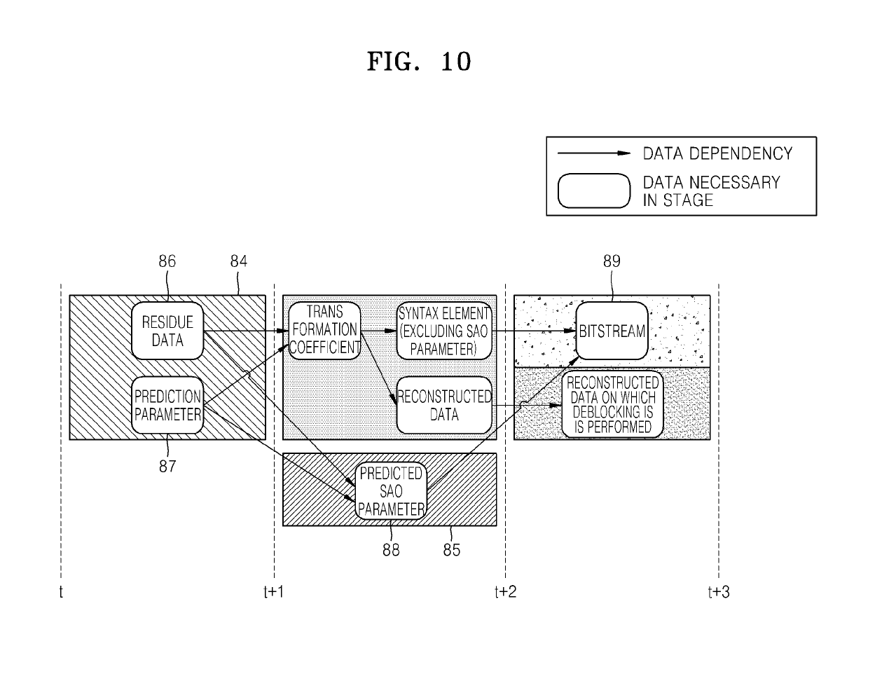

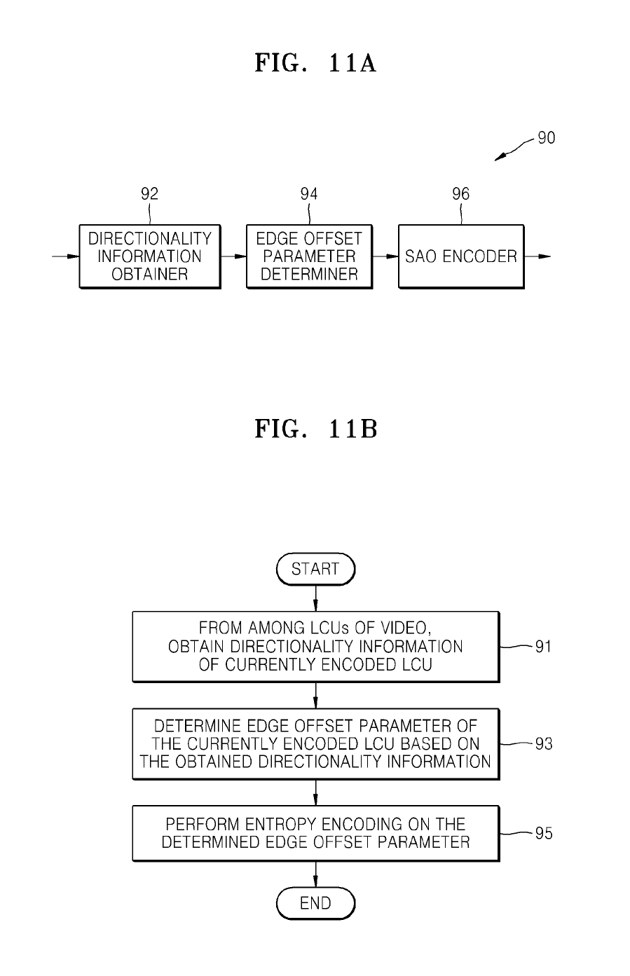

FIG. 10 illustrates another example of a method of encoding an SAO parameter, according to an embodiment.

Referring to FIG. 10, the SAO encoding apparatus 10 according to an embodiment may predict an SAO parameter 88 in an SAO stage 85 based on prediction information obtained before a pipeline stage (t+2˜t+3) that performs de-blocking of a currently encoded coding unit. The SAO encoding apparatus 10 may perform entropy encoding on the predicted SAO parameter 88 and generate a bitstream 89. In this regard, a stage 84 (t˜t+1) may determine a predetermined prediction parameter 87 and obtain and process a residue 86 from a predetermined prediction unit. The prediction parameter 87 may include a motion vector during inter prediction and an intra mode during intra prediction.

For example, the SAO encoding apparatus 10 may predict an SAO type of a current LCU as an edge type based on the motion vector during inter prediction and the intra mode during intra prediction, and predict an SAO class of the predicted edge class.

As another example, the SAO encoding apparatus 10 may predict a quantization error from the residue 86 and predict an SAO parameter.

According to the above-described embodiments, the SAO encoding apparatus 10 according to an embodiment may predict the SAO parameter based on prediction information obtained before performing de-blocking filtering on the current LCU, by using temporal and spatial correlations within a moving image. Thus, there is no data dependency between de-blocking and prediction of an SAO parameter, thereby reducing an amount of buffered data and power consumption.

FIGS. 11A and 11B, respectively, are a block diagram of a SAO encoding apparatus 90 and a flowchart of a method of encoding an SAO parameter of an edge type, according to one or more embodiments.

Referring to FIG. 11A, the SAO encoding apparatus 90 may include a directionality information obtainer 92, an edge offset parameter determiner 94, and an SAO encoder 96.

The SAO encoding apparatus 90 according to an embodiment receives an input of images such as slices of a video, splits each image into blocks, and encodes each block. A block may have a square shape, a rectangular shape, or an arbitrary geometrical shape, and is not limited to a data unit having a predetermined size. The block according to one or more embodiments may be a LCU or a coding unit among coding units according to a tree structure. Video encoding and decoding methods based on coding units according to a tree structure will be described below with reference to FIGS. 15 through 34.

The SAO encoding apparatus 90 according to an embodiment may split each input image into LCUs, and may output resultant data generated by performing prediction, transformation, and entropy encoding on samples of each LCU, as a bitstream. Samples of an LCU may be pixel value data of pixels included in the LCU.

The SAO encoding apparatus 90 according to an embodiment may individually encode LCUs of an image. The SAO encoding apparatus 10 may encode a current LCU based on coding units split from the current LCU and having a tree structure.

In order to encode the current LCU, the SAO encoding apparatus 10 may encode samples by performing intra prediction, inter prediction, transformation, and quantization on each of coding units included in the current LCU and having a tree structure.

Then, the SAO encoding apparatus 90 may reconstruct the encoded samples included in the current LCU by performing dequantization, inverse transformation, and inter prediction or intra compensation on each of the coding units having a tree structure so as to decode the coding units.

The SAO encoding apparatus 90 may also perform de-blocking on the reconstructed samples in the LCU so as to reduce image deterioration in block boundaries, and apply an SAO to the LCU on which de-blocking is performed so as to minimize an error between original pixels and reconstructed pixels. A detailed description of a method of applying the SAO has been provided with reference to FIGS. 3 through 5, and thus will be omitted here.

The SAO encoding apparatus 90 needs to determine an SAO parameter including an SAO type, an SAO class, and an offset value in order to apply the SAO. In this regard, the SAO type may indicate an edge type or a band type according to a pixel value classification method of the current LCU, the SAO class may indicate an edge direction according to the edge type or a band range according to the band type, and the offset value may indicate a difference value between reconstructed pixels and original pixels included in the SAO class.

Meanwhile, when the SAO type is determined as the edge type, the edge class according to the edge direction is determined as one of 0°, 90°, 45°, and 135°. However, a rate-distortion (RD) cost needs to be calculated by applying an SAO to all pixels included in a LCU with respect to the above four edge classes in order to determine the edge class. That is, the SAO encoding apparatus 90 needs to calculate edge offset values of all pixels, which complicates implementation of a circuit, and thus logic gates or code size and power consumption may increase.

Therefore, the SAO encoding apparatus 90 according to an embodiment may obtain directionality information of a currently encoded LCU and determine an edge offset parameter based on the directionality information.

A detailed operation of the SAO encoding apparatus 90 will now be described in detail with reference to FIG. 11B.

In operation 91, the directionality information obtainer 92 according to an embodiment may obtain directionality information of a currently encoded LCU among LCUs of a video. In this regard, an obtained edge direction may be one of 0°, 90°, 45°, and 135°.

The directionality information obtainer 92 according to an embodiment may obtain directionality information of an edge of the currently encoded LCU by using an edge detection algorithm. For example, the directionality information obtainer 92 may detect an edge of an LCU by using an edge detection algorithm such as a Sobel algorithm. The directionality information obtainer 92 may approximate a direction of the detected edge and determine the direction as one of 0°, 90°, 45°, and 135°.

The directionality information obtainer 92 according to an embodiment may obtain the directionality information by using intra mode information of the currently encoded LCU. Meanwhile, a LCU may include a plurality of prediction units and have at least one intra mode. In this case, the directionality information obtainer 92 may calculate a histogram regarding a plurality of intra modes included in the LCU and obtain a predetermined intra mode as the directionality information based on the histogram. As another example, the directionality information obtainer 92 may obtain the directionality information according to the number of occurrences of the intra modes in the LCU.

The directionality information obtainer 92 according to an embodiment may obtain the directionality information based on a motion vector of the currently encoded LCU. Meanwhile, the LCU may include a plurality of prediction units and have at least one motion vector. In this case, the directionality information obtainer 92 may calculate a histogram regarding motion vectors included in the LCU and obtain the directionality information based on the histogram. As another example, the directionality information obtainer 92 may obtain the directionality information according to sizes of the motion vectors in the LCU. The directionality information obtainer 92 may approximate a direction of a detected motion vector and determine the direction as one of 0°, 90°, 45°, and 135°.

In operation 93, the edge offset parameter determiner 94 according to an embodiment may determine an edge offset parameter of the currently encoded LCU based on the obtained directionality information. In this regard, the determined edge offset parameter may be the edge class described with reference to FIG. 4 above.

For example, the edge offset parameter determiner 94 may determine an edge class having the same direction as an obtained direction. That is, when the obtained directionality information is 0°, the edge offset parameter determiner 94 may determine a horizontal direction as the edge class.

As another example, the edge offset parameter determiner 94 may determine an edge class having directionality orthogonal to an obtained direction as a result of edge detection. That is, when the obtained directionality information is 0°, the edge offset parameter determiner 94 may determine a vertical direction as the edge class.

In operation 95, the SAO encoder 96 according to an embodiment may perform entropy encoding on the edge offset parameter. For example, the SAO encoder 96 may perform entropy encoding on the edge class determined by the edge offset parameter determiner 94.

The SAO encoding apparatus 90 according to an embodiment may determine an SAO operation value based on the edge class determined by the edge offset parameter determiner 94 and perform an SAO operation.

The SAO encoding apparatus 90 according to an embodiment may include a central processor (not shown) for collectively controlling the directionality information obtainer 92, the edge offset parameter determiner 94, and the SAO encoder 96. Alternatively, the directionality information obtainer 92, the edge offset parameter determiner 94, and the SAO encoder 96 may be driven by their individual processors (not shown) that cooperatively operate to control the SAO encoding apparatus 90. Alternatively, an external processor (not shown) outside the SAO encoding apparatus 10 according to an embodiment may control the directionality information obtainer 92, the edge offset parameter determiner 94, and the SAO encoder 96.

The SAO encoding apparatus 90 according to an embodiment may include one or more data storages (not shown) for storing input and output data of the directionality information obtainer 92, the edge offset parameter determiner 94, and the SAO encoder 96. The SAO encoding apparatus 90 may include a memory controller (not shown) for managing data input and output to and from the data storages.

In order to perform a video encoding operation including transformation and to output a result of the video encoding operation, the SAO encoding apparatus 90 according to an embodiment may operate in association with an internal or external video encoding processor. The internal video encoding processor of the SAO encoding apparatus 90 according to an embodiment may be an independent processor for performing a video encoding operation. Also, the SAO encoding apparatus 90, a central processing unit, or a graphic processing unit may include a video encoding processor module to perform a basic video encoding operation.

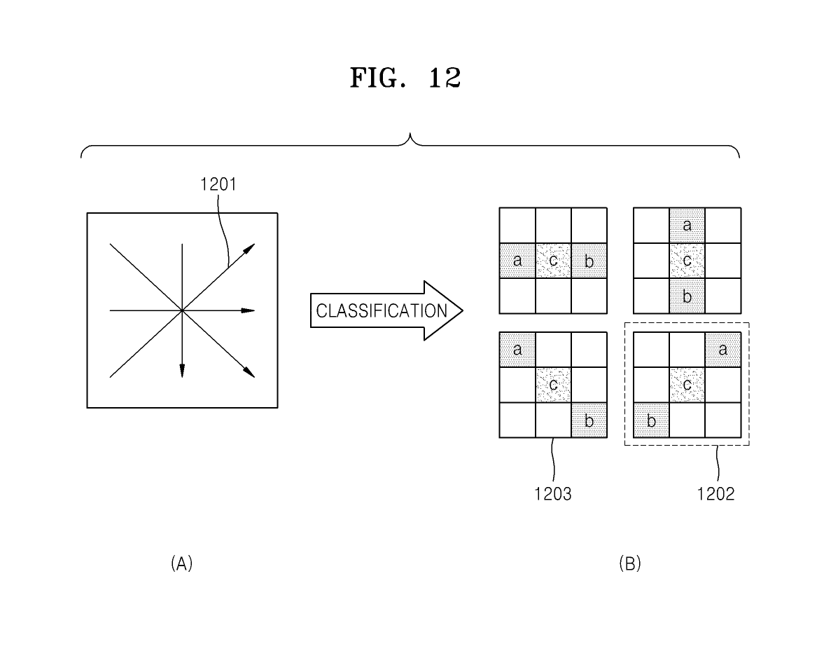

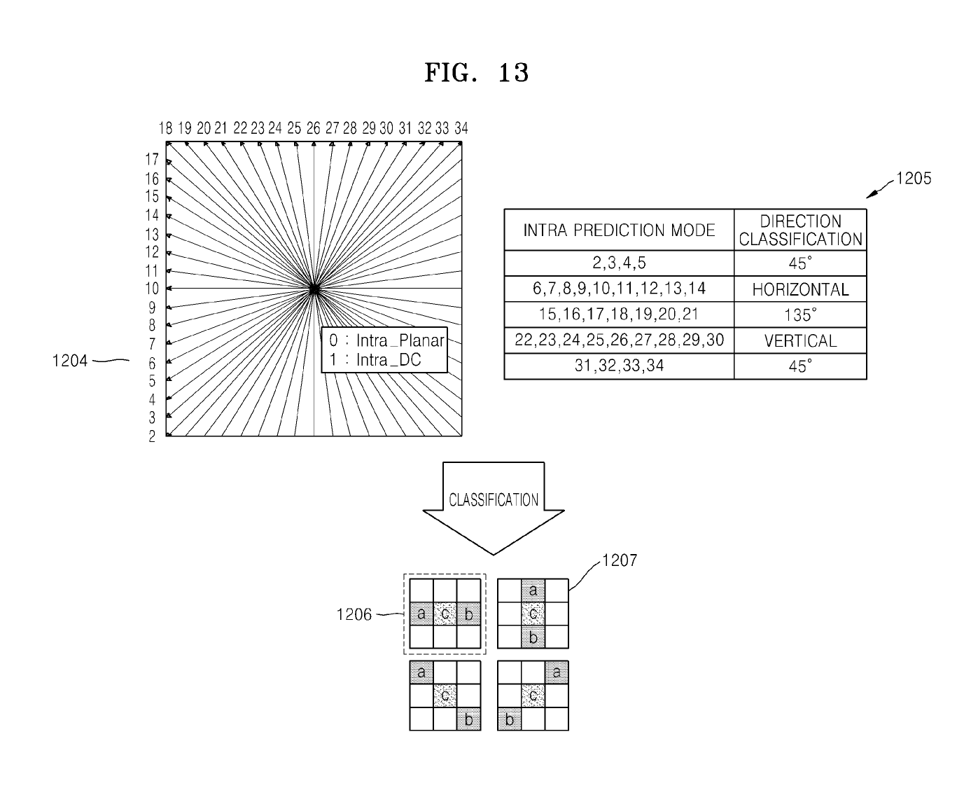

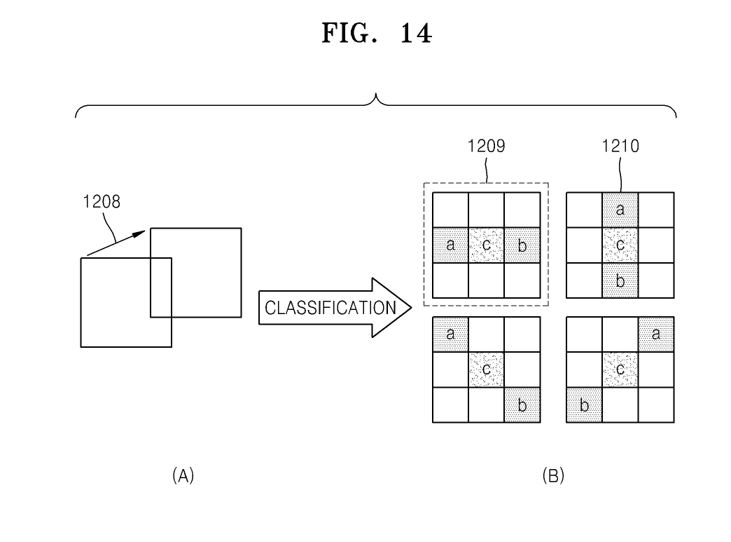

A method of determining an edge offset parameter based on directionality information of a LCU will now be described in detail with reference to FIGS. 12 through 14.

FIG. 12 is diagram for explaining an example of a method of encoding an SAO parameter of an edge type, according to an embodiment.

Referring to FIG. 12, the directionality information obtainer 92 may obtain directionality information of an edge of a currently encoded LCU by using an edge detection algorithm. In this regard, the directionality information obtainer 92 may detect an edge 1201 of a LCU by using an edge detection algorithm such as a Sobel algorithm. The directionality information obtainer 92 may approximate a direction of the detected edge 1201 and determine the direction as one of 0°, 90°, 45°, and 135°. For example, the detected edge 1201 may have a directionality of 135°.

The edge offset parameter determiner 94 according to an embodiment may determine an edge class of the currently encoded LCU based on the obtained directionality information. For example, the edge offset parameter determiner 94 may select an edge class 1202 having the same directionality as that of the direction of the edge 1201 from among four offset classes of FIG. 12. As another example, the edge offset parameter determiner 94 may select an edge class 1203 having directionality orthogonal to the direction of the edge 1201 from among the four offset classes of FIG. 12.

FIG. 13 is diagram for explaining another example of a method of encoding an SAO parameter of an edge type, according to an embodiment.

Referring to FIG. 13, the directionality information obtainer 92 may obtain directionality information by using intra mode information of a currently encoded LCU. That is, the directionality information obtainer 92 may approximate 35 intra modes of a coding unit as four directions based on a previously determined table 1205. For example, when 8 intra modes are obtained from the currently encoded LCU, the directionality information obtainer 92 may determine that an LCU has directionality in a horizontal direction based on the table 1205.

Meanwhile, the LCU may include a plurality of prediction units and have at least one intra mode. In this case, the directionality information obtainer 92 may calculate a histogram regarding the intra modes included in the LCU and obtain a predetermined intra mode as the directionality information based on the histogram. As another example, the directionality information obtainer 92 may obtain the directionality information according to the number of occurrences of the intra modes in the LCU.

The edge offset parameter determiner 94 according to an embodiment may determine an edge class of the currently encoded LCU based on the obtained directionality information. For example, the edge offset parameter determiner 94 may select an edge class 1206 having the same directionality as that of an obtained direction 1204 from among four offset classes of FIG. 13. As another example, the edge offset parameter determiner 94 may select an edge class 1207 having a directionality orthogonal to the obtained direction 1204 from among the four offset classes of FIG. 13.

FIG. 14 is diagram for explaining another example of a method of encoding an SAO parameter of an edge type, according to an embodiment.

Referring to FIG. 14, the directionality information obtainer 92 may obtain directionality information based on a motion vector 1208 of a currently encoded LCU. In this regard, the directionality information obtainer 92 may approximate a direction of the motion vector 1208 and determine the direction as one of 0°, 90°, 45°, and 135°. For example, the direction of the motion vector 1208 of FIG. 14 may be determined as 0°.

Meanwhile, an LCU may include a plurality of prediction units and have at least one motion vector. In this case, the directionality information obtainer 92 may calculate a histogram regarding the motion vectors included in the LCU and obtain the directionality information based on the histogram. As another example, the directionality information obtainer 92 may obtain the directionality information according to sizes of the motion vectors in the LCU.

The edge offset parameter determiner 94 according to an embodiment may determine an edge class of the currently encoded LCU based on the obtained directionality information. For example, the edge offset parameter determiner 94 may select an edge class 1209 having the same directionality as that of the direction of the motion vector 1208 from among four offset classes of FIG. 14. As another example, the edge offset parameter determiner 94 may select an edge class 1210 having a directionality orthogonal to the direction of the motion vector 1208 from among the four offset classes of FIG. 14.

On the other hand, as described above, the SAO encoding apparatus 90 provides a method of determining an edge class based on directionality information obtained in a LCU, thereby improving inefficiency of implementation of a circuit and power consumption.

In the SAO encoding apparatus 10 and the SAO decoding apparatus 20, as described above, video data may be split into LCUs, each LCU may be encoded and decoded based on coding units having a tree structure, and each LCU may determine offset values according to pixel classification. Hereinafter, an embodiment in which an SAO operation according to pixel classification is used in a video encoding method and a video decoding method based on coding units having a tree structure according to various embodiments will be described with reference to FIGS. 15 through 34.

FIG. 15 is a block diagram of a video encoding apparatus 100 based on coding units according to a tree structure, according to one or more embodiments.

The video encoding apparatus 100 involving video prediction based on coding units according to a tree structure includes a LCU splitter 110, a coding unit determiner 120, and an outputter 130.

The LCU splitter 110 may split a current picture based on a LCU that is a coding unit having a maximum size for a current picture of an image. If the current picture is larger than the LCU, image data of the current picture may be split into the at least one LCU. The LCU according to one or more embodiments may be a data unit having a size of 32×32, 64×64, 128×128, 256×256, etc., wherein a shape of the data unit is a square having a width and length in squares of 2. The image data may be output to the coding unit determiner 120 according to the at least one LCU.

A coding unit according to one or more embodiments may be characterized by a maximum size and a depth. The depth denotes the number of times the coding unit is spatially split from the LCU, and as the depth increases, deeper coding units according to depths may be split from the LCU to a smallest coding unit (SCU). A depth of the LCU is an uppermost depth and a depth of the SCU is a lowermost depth. Since a size of a coding unit corresponding to each depth decreases as the depth of the LCU increases, a coding unit corresponding to an upper depth may include a plurality of coding units corresponding to lower depths.

As described above, the image data of the current picture is split into the LCUs according to a maximum size of the coding unit, and each of the LCUs may include deeper coding units that are split according to depths. Since the LCU according to one or more embodiments is split according to depths, the image data of the space domain included in the LCU may be hierarchically classified according to depths.

A maximum depth and a maximum size of a coding unit, which limit the total number of times a height and a width of the LCU are hierarchically split, may be predetermined.

The coding unit determiner 120 encodes at least one split region obtained by splitting a region of the LCU according to depths, and determines a depth to output a finally encoded image data according to the at least one split region. In other words, the coding unit determiner 120 determines a depth by encoding the image data in the deeper coding units according to depths, according to the LCU of the current picture, and selecting a depth having the least encoding error. The determined depth and the encoded image data according to the determined depth are output to the outputter 130.

The image data in the LCU is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one depth may be selected for each LCU.

The size of the LCU is split as a coding unit is hierarchically split according to depths, and as the number of coding units increases. Also, even if coding units correspond to the same depth in one LCU, it is determined whether to split each of the coding units corresponding to the same depth to a lower depth by measuring an encoding error of the image data of the each coding unit, separately. Accordingly, even when image data is included in one LCU, the encoding errors may differ according to regions in the one LCU, and thus the depths may differ according to regions in the image data. Thus, one or more depths may be determined in one LCU, and the image data of the LCU may be divided according to coding units of at least one depth.

Accordingly, the coding unit determiner 120 may determine coding units having a tree structure included in the LCU. The ‘coding units having a tree structure’ according to one or more embodiments include coding units corresponding to a depth determined to be the depth, from among all deeper coding units included in the LCU. A coding unit of a depth may be hierarchically determined according to depths in the same region of the LCU, and may be independently determined in different regions. Similarly, a depth in a current region may be independently determined from a depth in another region.

A maximum depth according to one or more embodiments is an index related to the number of splitting times from a LCU to an SCU. A first maximum depth according to one or more embodiments may denote the total number of splitting times from the LCU to the SCU. A second maximum depth according to one or more embodiments may denote the total number of depth levels from the LCU to the SCU. For example, when a depth of the LCU is 0, a depth of a coding unit, in which the LCU is split once, may be set to 1, and a depth of a coding unit, in which the LCU is split twice, may be set to 2. Here, if the SCU is a coding unit in which the LCU is split four times, 5 depth levels of depths 0, 1, 2, 3, and 4 exist, and thus the first maximum depth may be set to 4, and the second maximum depth may be set to 5.

Prediction encoding and transformation may be performed according to the LCU. The prediction encoding and the transformation are also performed based on the deeper coding units according to a depth equal to or depths less than the maximum depth, according to the LCU.

Since the number of deeper coding units increases whenever the LCU is split according to depths, encoding, including the prediction encoding and the transformation, is performed on all of the deeper coding units generated as the depth increases. For convenience of description, the prediction encoding and the transformation will now be described based on a coding unit of a current depth, in a LCU.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the LCU, the prediction encoding may be performed based on a coding unit corresponding to a depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the data unit for the transformation may include a data unit for an intra mode and a data unit for an inter mode.

The transformation unit in the coding unit may be recursively split into smaller sized regions in the similar manner as the coding unit according to the tree structure. Thus, residues in the coding unit may be divided according to the transformation unit having the tree structure according to transformation depths.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Encoding information according to coding units corresponding to a depth requires not only information about the depth, but also about information related to prediction encoding and transformation. Accordingly, the coding unit determiner 120 not only determines a depth having a least encoding error, but also determines a partition mode in a prediction unit, a prediction mode according to prediction units, and a size of a transformation unit for transformation.

Coding units according to a tree structure in a LCU and methods of determining a prediction unit/partition, and a transformation unit, according to one or more embodiments, will be described in detail below with reference to FIGS. 7 through 19.

The coding unit determiner 120 may measure an encoding error of deeper coding units according to depths by using Rate-Distortion Optimization based on Lagrangian multipliers.

The outputter 130 outputs the image data of the LCU, which is encoded based on the at least one depth determined by the coding unit determiner 120, and information about the encoding mode according to the depth, in bitstreams.

The encoded image data may be obtained by encoding residues of an image.

The information about the encoding mode according to depth may include information about the depth, about the partition mode in the prediction unit, the prediction mode, and the size of the transformation unit.

The information about the depth may be defined by using splitting information according to depths, which indicates whether encoding is performed on coding units of a lower depth instead of a current depth. If the current depth of the current coding unit is the depth, image data in the current coding unit is encoded and output, and thus the splitting information may be defined not to split the current coding unit to a lower depth. Alternatively, if the current depth of the current coding unit is not the depth, the encoding is performed on the coding unit of the lower depth, and thus the splitting information may be defined to split the current coding unit to obtain the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one LCU, and information about at least one encoding mode is determined for a coding unit of a depth, information about at least one encoding mode may be determined for one LCU. Also, a depth of the image data of the LCU may be different according to locations since the image data is hierarchically split according to depths, and thus splitting information may be set for the image data.

Accordingly, the outputter 130 may assign corresponding splitting information to at least one of the coding unit, the prediction unit, and a minimum unit included in the LCU.

The minimum unit according to one or more embodiments is a square data unit obtained by splitting the SCU constituting the lowermost depth by 4. Alternatively, the minimum unit according to an embodiment may be a maximum square data unit that may be included in all of the coding units, prediction units, partition units, and transformation units included in the LCU.

For example, the encoding information output by the outputter 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The outputter 130 may encode and output SAO parameters related to the SAO operation described above with reference to FIGS. 1A through 14.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each LCU, based on the size of the LCU and the maximum depth determined considering characteristics of the current picture. Also, since encoding may be performed on each LCU by using any one of various prediction modes and transformations, an optimum encoding mode may be determined considering characteristics of the coding unit of various image sizes.

Thus, if an image having a high resolution or a large data amount is encoded in a macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

The video encoding apparatus 100 of FIG. 15 may perform operation of the SAO encoding apparatus 10 described above with reference to FIGS. 1A and 11A.

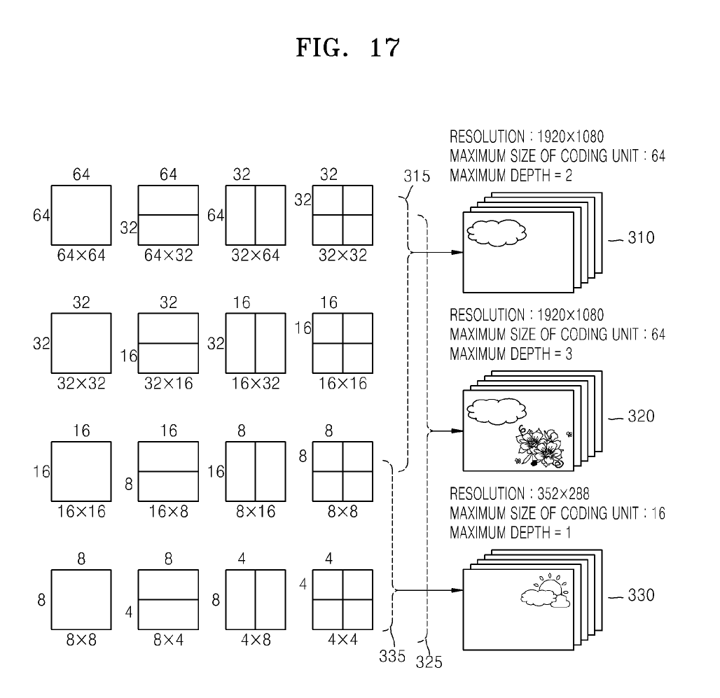

FIG. 16 is a block diagram of a video decoding apparatus 200 based on coding units having a tree structure, according to one or more embodiments.

The video decoding apparatus 200 that involves video prediction based on coding units having a tree structure includes a receiver 210, an image data and encoding information extractor 220, and an image data decoder 230.

Definitions of various terms, such as a coding unit, a depth, a prediction unit, a transformation unit, and information about various encoding modes, for decoding operations of the video decoding apparatus 200 are identical to those described with reference to FIG. 8 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each LCU, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts splitting information and encoding information for the coding units having a tree structure according to each LCU, from the parsed bitstream. The extracted splitting information and encoding information are output to the image data decoder 230. In other words, the image data in a bit stream is split into the LCU so that the image data decoder 230 decodes the image data for each LCU.

The splitting information and encoding information according to the LCU may be set for at least one piece of splitting information corresponding to the depth, and encoding information according to the depth may include information about a partition mode of a corresponding coding unit corresponding to the depth, information about a prediction mode, and splitting information of a transformation unit. Also, splitting information according to depths may be extracted as the information about a final depth.

The splitting information and the encoding information according to each LCU extracted by the image data and encoding information extractor 220 is splitting information and encoding information determined to generate a minimum encoding error when an encoder, such as the video encoding apparatus 100, repeatedly performs encoding for each deeper coding unit according to depths according to each LCU. Accordingly, the video decoding apparatus 200 may reconstruct an image by decoding the image data according to a depth and an encoding mode that generates the minimum encoding error.

Since the splitting information and the encoding information may be assigned to a predetermined data unit from among a corresponding coding unit, a prediction unit, and a minimum unit, the image data and encoding information extractor 220 may extract the splitting information and the encoding information according to the predetermined data units. If splitting information and encoding information of a corresponding LCU are recorded according to predetermined data units, the predetermined data units to which the same splitting information and encoding information are assigned may be inferred to be the data units included in the same LCU.

The image data decoder 230 reconstructs the current picture by decoding the image data in each LCU based on the splitting information and the encoding information according to the LCUs. In other words, the image data decoder 230 may decode the encoded image data based on the extracted information about the partition mode, the prediction mode, and the transformation unit for each coding unit from among the coding units having the tree structure included in each LCU. A decoding process may include a prediction including intra prediction and motion compensation, and an inverse transformation.

The image data decoder 230 may perform intra prediction or motion compensation according to a partition and a prediction mode of each coding unit, based on the information about the partition mode and the prediction mode of the prediction unit of the coding unit according to depths.

In addition, the image data decoder 230 may read information about a transformation unit according to a tree structure for each coding unit so as to perform inverse transformation based on transformation units for each coding unit, for inverse transformation for each LCU. Via the inverse transformation, a pixel value of the space domain of the coding unit may be reconstructed.

The image data decoder 230 may determine a final depth of a current LCU by using splitting information according to depths. If the splitting information indicates that image data is no longer split in the current depth, the current depth is the final depth. Accordingly, the image data decoder 230 may decode encoded data in the current LCU by using the information about the partition mode of the prediction unit, the information about the prediction mode, and the splitting information of the transformation unit for each coding unit corresponding to the depth.

In other words, data units containing the encoding information including the same splitting information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

Also, the video decoding apparatus 200 of FIG. 16 may perform operation of the SAO decoding apparatus 20 described above with reference to FIG. 2A.

FIG. 17 is a diagram for describing a concept of coding units according to one or more embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 17 denotes a total number of splits from a LCU to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a LCU having a long axis size of 64, and coding units having long axis sizes of 32 and 16 since depths are deepened to two layers by splitting the LCU twice. Since the maximum depth of the video data 330 is 1, coding units 335 of the video data 330 may include a LCU having a long axis size of 16, and coding units having a long axis size of 8 since depths are deepened to one layer by splitting the LCU once.

Since the maximum depth of the video data 320 is 3, coding units 325 of the video data 320 may include a LCU having a long axis size of 64, and coding units having long axis sizes of 32, 16, and 8 since the depths are deepened to 3 layers by splitting the LCU three times. As a depth increases, detailed information may be precisely expressed.

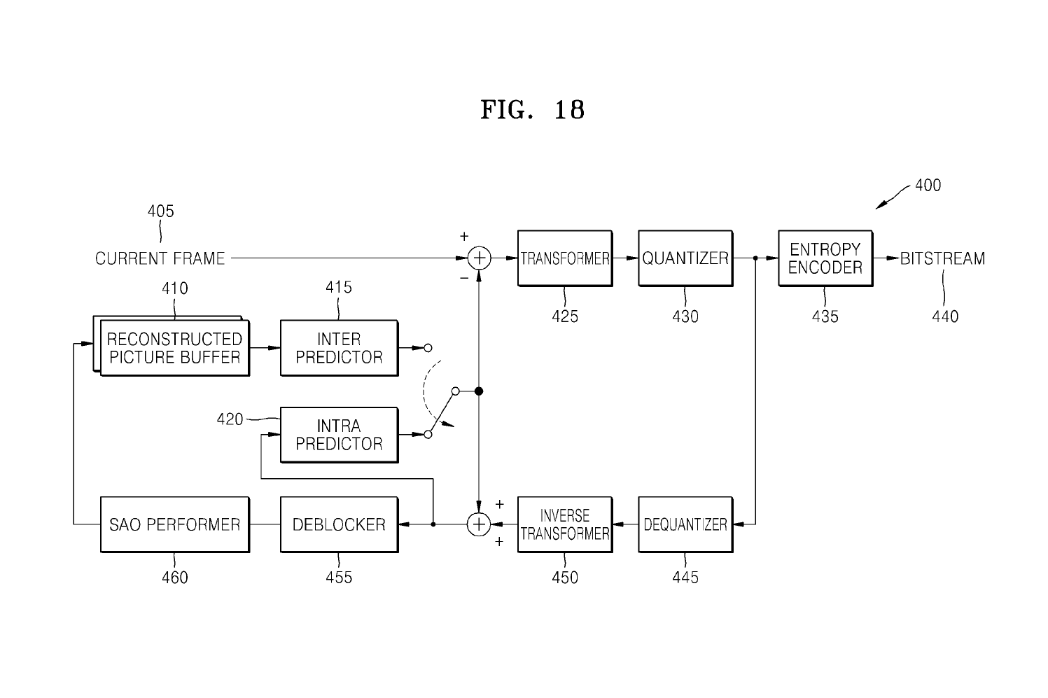

FIG. 18 is a block diagram of an image encoder 400 based on coding units, according to one or more embodiments.

The image encoder 400 performs operations necessary for encoding image data in the coding unit determiner 120 of the video encoding apparatus 100. In other words, an intra predictor 420 performs intra prediction on coding units in an intra mode according to prediction units, from among a current frame 405, and an inter predictor 415 performs inter prediction on coding units in an inter mode by using a current image 405 and a reference image obtained from a reconstructed picture buffer 410 according to prediction units. The current image 405 may be split into LCUs and then the LCUs may be sequentially encoded. In this regard, the LCUs that are to be split into coding units having a tree structure may be encoded.

Residue data is generated by removing prediction data regarding coding units of each mode that is output from the intra predictor 420 or the inter predictor 415 from data regarding encoded coding units of the current image 405, and is output as a quantized transformation coefficient according to transformation units through a transformer 425 and a quantizer 430. The quantized transformation coefficient is reconstructed as the residue data in a space domain through a dequantizer 445 and an inverse transformer 450. The reconstructed residue data in the space domain is added to prediction data for coding units of each mode that is output from the intra predictor 420 or the inter predictor and thus is reconstructed as data in a space domain for coding units of the current image 405. The reconstructed data in the space domain is generated as reconstructed images through a de-blocker 455 and an SAO performer 460 and the reconstructed images are stored in the reconstructed picture buffer 410. The reconstructed images stored in the reconstructed picture buffer 410 may be used as reference images for inter prediction of another image. The transformation coefficient quantized by the transformer 425 and the quantizer 430 may be output as a bitstream 440 through an entropy encoder 435.

In order for the image encoder 400 to be applied in the video encoding apparatus 100, all elements of the image encoder 400, i.e., the inter predictor 415, the intra predictor 420, the transformer 425, the quantizer 430, the entropy encoder 435, the dequantizer 445, the inverse transformer 450, the de-blocker 455, and the SAO performer 460, perform operations based on each coding unit among coding units having a tree structure according to each LCU.

In particular, the intra predictor 410, the motion estimator 420, and the motion compensator 425 determines partitions and a prediction mode of each coding unit from among the coding units having a tree structure while considering the maximum size and the maximum depth of a current LCU, and the transformer 430 determines the size of the transformation unit in each coding unit from among the coding units having a tree structure.

Specifically, the intra predictor 420 and the inter predictor 415 may determine a partition mode and a prediction mode of each coding unit among the coding units having a tree structure in consideration of a maximum size and a maximum depth of a current LCU, and the transformer 425 may determine whether to split a transformation unit having a quad tree structure in each coding unit among the coding units having a tree structure.

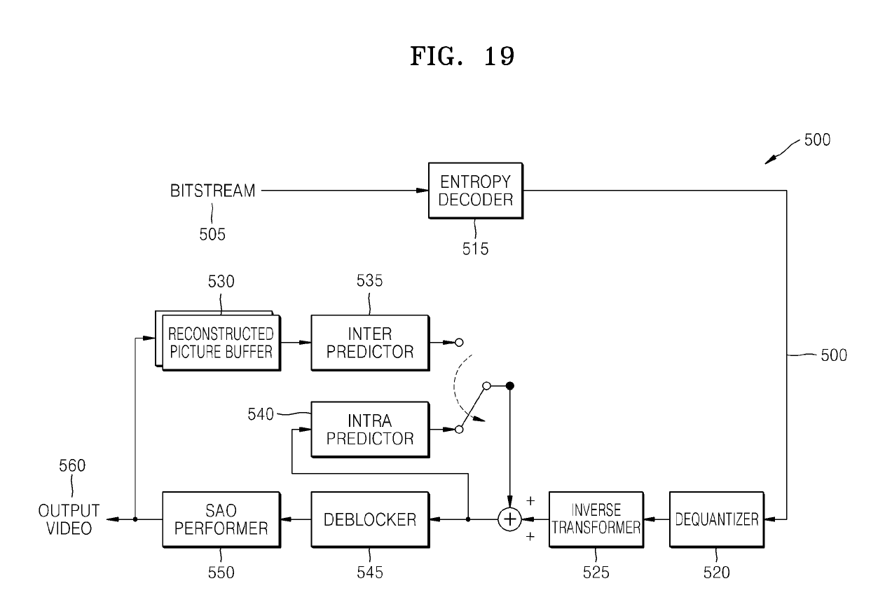

FIG. 19 is a block diagram of an image decoder 500 based on coding units, according to one or more embodiments.

An entropy decoder 515 parses encoded image data to be decoded and information about encoding required for decoding from a bitstream 505. The encoded image data is a quantized transformation coefficient from which residue data is reconstructed by a dequantizer 520 and an inverse transformer 525.

An intra predictor 540 performs intra prediction on coding units in an intra mode according to each prediction unit. An inter predictor 535 performs inter prediction on coding units in an inter mode from among the current image 405 for each prediction unit by using a reference image obtained from a reconstructed picture buffer 530.

Prediction data and residue data regarding coding units of each mode, which passed through the intra predictor 540 and the inter predictor 535, are summed, and thus data in a space domain regarding coding units of the current image 405 may be reconstructed, and the reconstructed data in the space domain may be output as a reconstructed image 560 through a de-blocker 545 and an SAO performer 550. Reconstructed images stored in the reconstructed picture buffer 530 may be output as reference images.

In order to decode the image data in the image data decoder 230 of the video decoding apparatus 200, operations after the entropy decoder 515 of the image decoder 500 according to an embodiment may be performed.

In order for the image decoder 500 to be applied in the video decoding apparatus 200 according to an embodiment, all elements of the image decoder 500, i.e., the entropy decoder 515, the dequantizer 520, the inverse transformer 525, the inter predictor 535, the de-blocker 545, and the SAO performer 550 may perform operations based on coding units having a tree structure for each LCU.

In particular, the SAO performer 550 and the inter predictor 535 may determine a partition and a prediction mode for each of the coding units having a tree structure, and the inverse transformer 525 may determine whether to split a transformation unit having a quad tree structure for each of the coding units.

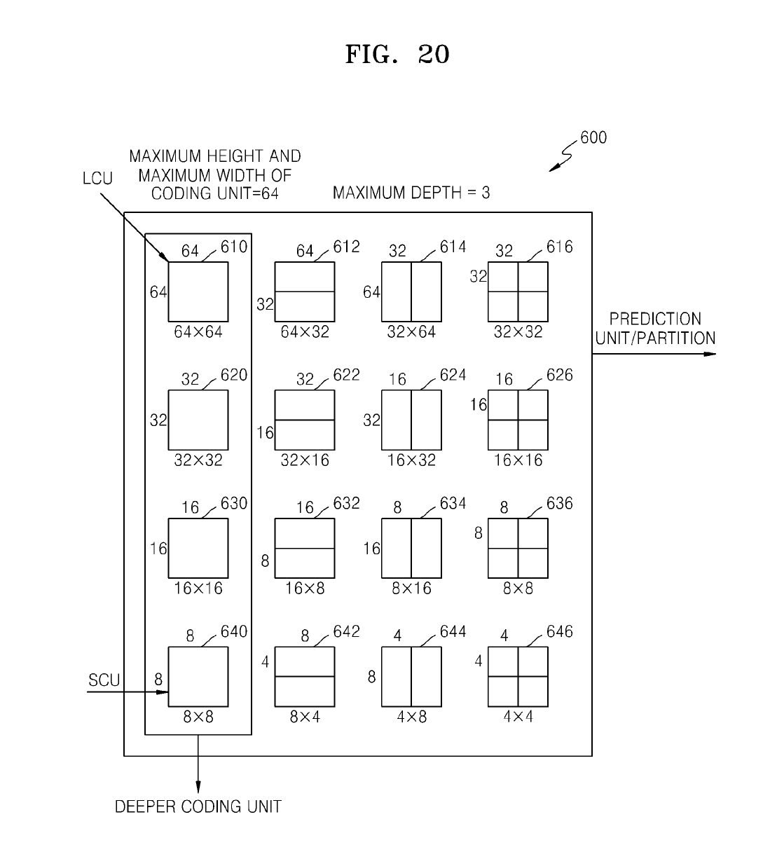

FIG. 20 is a diagram illustrating deeper coding units according to depths, and partitions, according to one or more embodiments.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to one or more embodiments, the maximum height and the maximum width of the coding units are each 64, and the maximum depth is 3. In this case, the maximum depth refers to a total number of times the coding unit is split from the LCU to the SCU. Since a depth increases along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a LCU in the hierarchical structure 600, wherein a depth is 0 and a size, i.e., a height by width, is 64×64. The depth increases along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 8×8 and a depth of 3 is an SCU.

The prediction unit and the partitions of a coding unit are arranged along the horizontal axis according to each depth. In other words, if the coding unit 610 having a size of 64×64 and a depth of 0 is a prediction unit, the prediction unit may be split into partitions include in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

In order to determine a final depth of the coding units constituting the LCU 610, the coding unit determiner 120 of the video encoding apparatus 100 performs encoding for coding units corresponding to each depth included in the LCU 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth increases along the vertical axis of the hierarchical structure 600. A depth and a partition having the minimum encoding error in the coding unit 610 may be selected as the final depth and a partition mode of the coding unit 610.

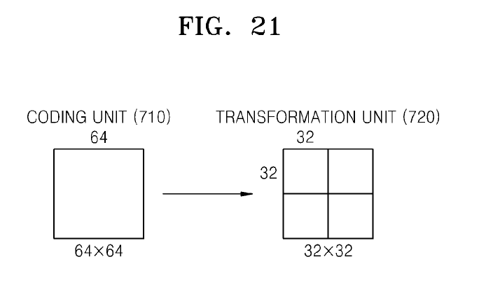

FIG. 21 is a diagram for describing a relationship between a coding unit 710 and transformation units 720, according to one or more embodiments.

The video encoding apparatus 100 or the video decoding apparatus 200 encodes or decodes an image according to coding units having sizes smaller than or equal to a LCU for each LCU. Sizes of transformation units for transformation during encoding may be selected based on data units that are not larger than a corresponding coding unit.

For example, in the video encoding apparatus 100 or the video decoding apparatus 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

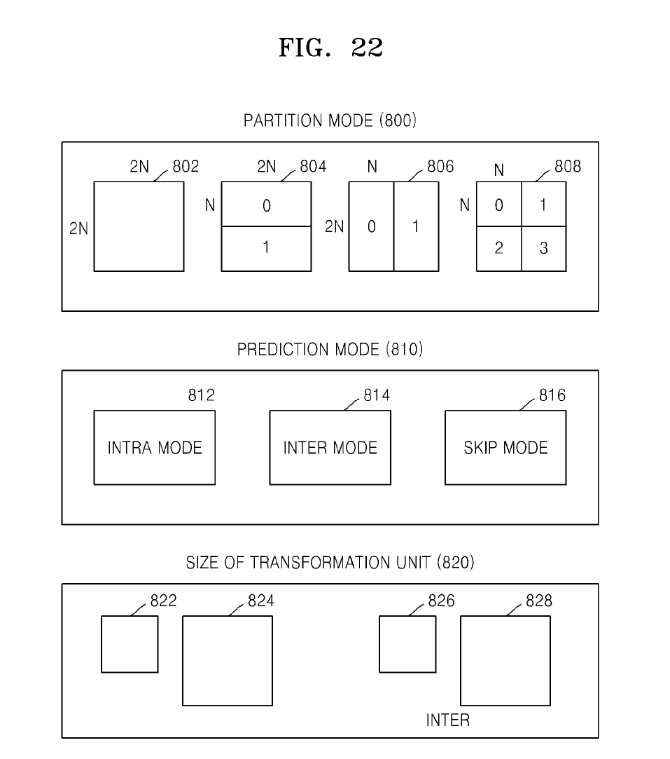

FIG. 22 is a diagram fro describing encoding information of coding units corresponding to a depth, according to one or more embodiments.

The outputter 130 of the video encoding apparatus 100 may encode and transmit information 800 about a partition mode, information 810 about a prediction mode, and information 820 about a size of a transformation unit for each coding unit corresponding to a final depth, as information about an encoding mode.

The information 800 indicates information about a mode of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition mode is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 may extract and use the information 800, 810, and 820 for decoding, according to each deeper coding unit.

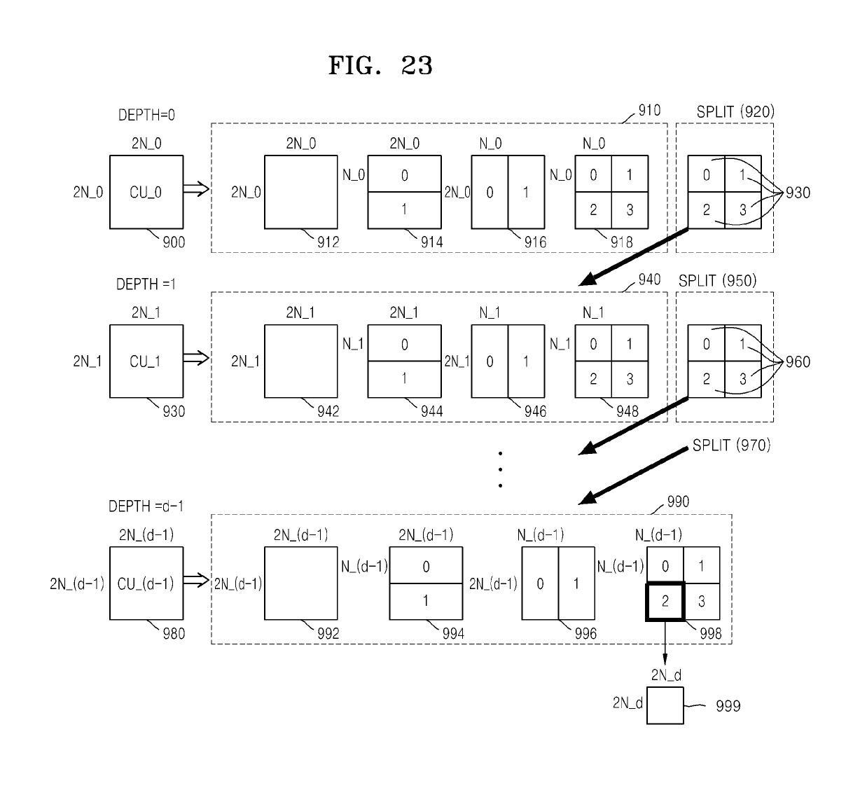

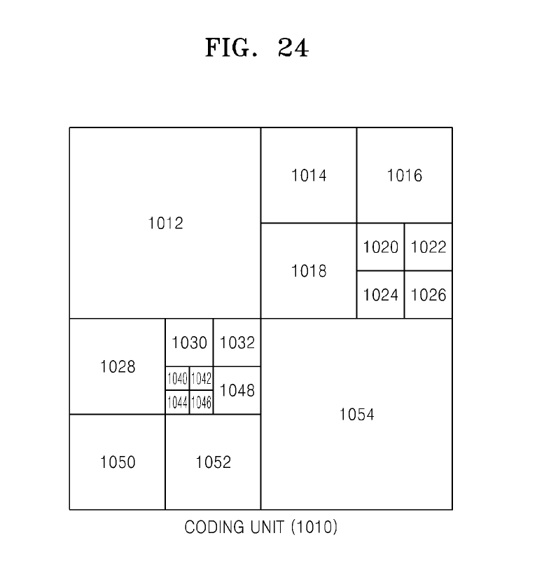

FIG. 23 is a diagram of deeper coding units according to depths, according to one or more embodiments.

Splitting information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition mode 912 having a size of 2N_{—}0×2N_{—}0, a partition mode 914 having a size of 2N_{—}0×N_{—}0, a partition mode 916 having a size of N_{—}0×2N_{—}0, and a partition mode 918 having a size of N_{—}0×N_{—}0. FIG. 23 only illustrates the partition modes 912 through 918 which are obtained by symmetrically splitting the prediction unit 910, but a partition mode is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition mode. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode is performed only on the partition having the size of 2N_{—}0×2N_{—}0.

If an encoding error is smallest in one of the partition modes 912 through 916, the prediction unit 910 may not be split into a lower depth.

If the encoding error is the smallest in the partition mode 918, a depth is changed from 0 to 1 to split the partition mode 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition mode 942 having a size of 2N_{—}1×2N_{—}1, a partition mode 944 having a size of 2N_{—}1×N_{—}1, a partition mode 946 having a size of N_{—}1×2N_{—}1, and a partition mode 948 having a size of N_{—}1×N_{—}1.

If an encoding error is the smallest in the partition mode 948, a depth is changed from 1 to 2 to split the partition mode 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed up to when a depth becomes d−1, and splitting information may be encoded as up to when a depth is one of 0 to d−2. In other words, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes 992 through 998 to search for a partition mode having a minimum encoding error.

Even when the partition mode 998 has the minimum encoding error, since a maximum depth is d, a coding unit CU_(d−1) having a depth of d−1 is no longer split to a lower depth, and a depth for the coding units constituting a current LCU 900 is determined to be d−1 and a partition mode of the current LCU 900 may be determined to be N_(d−1)×N_(d−1). Also, since the maximum depth is d and an SCU 980 having a lowermost depth of d−1 is no longer split to a lower depth, splitting information for the SCU 980 is not set.

A data unit 999 may be a ‘minimum unit’ for the current LCU. A minimum unit according to one or more embodiments may be a square data unit obtained by splitting an SCU 980 by 4. By performing the encoding repeatedly, the video encoding apparatus 100 may select a depth having the least encoding error by comparing encoding errors according to depths of the coding unit 900 to determine a depth, and set a corresponding partition mode and a prediction mode as an encoding mode of the depth.

As such, the minimum encoding errors according to depths are compared in all of the depths of 1 through d, and a depth having the least encoding error may be determined as a depth. The depth, the partition mode of the prediction unit, and the prediction mode may be encoded and transmitted as information about an encoding mode. Also, since a coding unit is split from a depth of 0 to a depth, only splitting information of the depth is set to 0, and splitting information of depths excluding the depth is set to 1.

The image data and encoding information extractor 220 of the video decoding apparatus 200 may extract and use the information about the depth and the prediction unit of the coding unit 900 to decode the partition 912. The video decoding apparatus 200 may determine a depth, in which splitting information is 0, as a depth by using splitting information according to depths, and use information about an encoding mode of the corresponding depth for decoding.

FIGS. 24 through 26 are diagrams for describing a relationship between coding units 1010, prediction units 1060, and transformation units 1070, according to one or more embodiments.

The coding units 1010 are coding units having a tree structure, corresponding to depths determined by the video encoding apparatus 100, in a LCU. The prediction units 1060 are partitions of prediction units of each of the coding units 1010, and the transformation units 1070 are transformation units of each of the coding units 1010.

When a depth of a LCU is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition modes in the coding units 1014, 1022, 1050, and 1054 have a size of 2N×N, partition modes in the coding units 1016, 1048, and 1052 have a size of N×2N, and a partition mode of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding and decoding apparatuses 100 and 200 may perform intra prediction, motion estimation, motion compensation, transformation, and inverse transformation individually on a data unit in the same coding unit.

Accordingly, encoding is recursively performed on each of coding units having a hierarchical structure in each region of a LCU to determine an optimum coding unit, and thus coding units having a recursive tree structure may be obtained. Encoding information may include splitting information about a coding unit, information about a partition mode, information about a prediction mode, and information about a size of a transformation unit. Table 1 shows the encoding information that may be set by the video encoding and decoding apparatuses 100 and 200.

TABLE 1

| Splitting information 0 | | | | | |
|---|---|---|---|---|---|
| (Encoding on Coding Unit having Size of | | | | | |
| 2N × 2N and Current Depth of d) | | | | | |
| | | | Size of Transformation Unit | | |
| | | | | Splitting | |
| | Partition mode | | Splitting | information 1 | |
| | Symmetrical | | information 0 of | of | |
| Prediction | Partition | Asymmetrical | Transformation | Transformation | Splitting |
| Mode | mode | Partition mode | Unit | Unit | information 1 |
| Intra | 2N × 2N | 2N × nU | 2N × 2N | N × N | Repeatedly |
| Inter | 2N × N | 2N × nD | | (Symmetrical | Encode Coding |
| Skip | N × 2N | nL × 2N | | Type) | Units having |
| (Only | N × N | nR × 2N | | N/2 × N/2 | Lower Depth of |
| 2N × 2N) | | | | (Asymmetrical | d + 1 |
| | | | | Type) | |

The outputter 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Splitting information indicates whether a current coding unit is split into coding units of a lower depth. If splitting information of a current depth d is 0, a depth, in which a current coding unit is no longer split into a lower depth, is a final depth, and thus information about a partition mode, prediction mode, and a size of a transformation unit may be defined for the final depth. If the current coding unit is further split according to the splitting information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1

The size of the transformation unit may be set to be two types in the intra mode and two types in the inter mode. In other words, if splitting information of the transformation unit is 0, the size of the transformation unit may be 2N×2N, which is the size of the current coding unit. If splitting information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition mode of the current coding unit is an asymmetrical partition mode, the size of the transformation unit may be N/2×N/2.

The encoding information about coding units having a tree structure may include at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a LCU may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

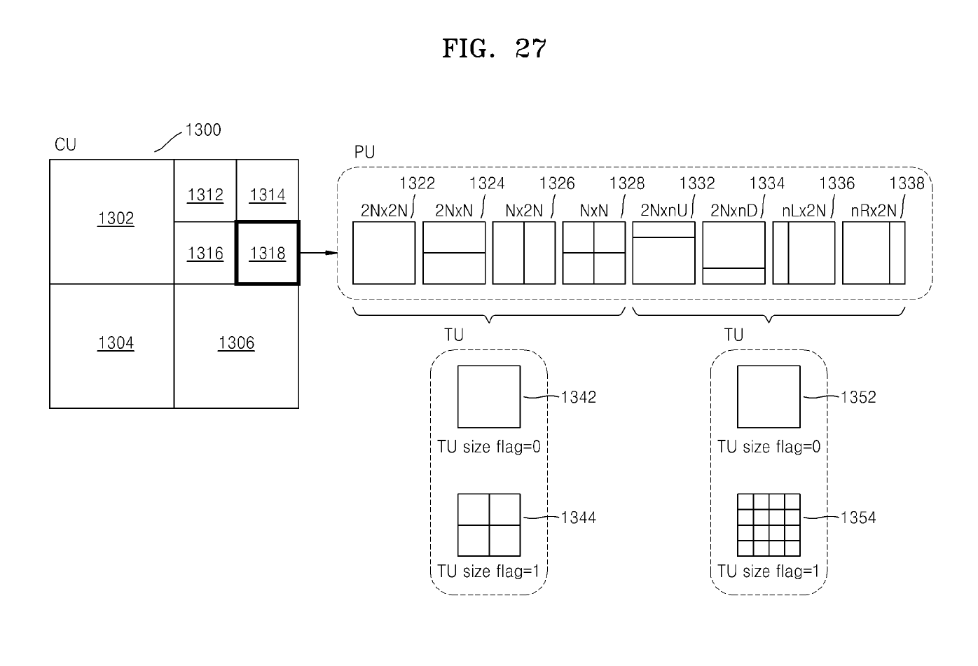

FIG. 27 is a diagram for describing a relationship between a coding unit, a prediction unit, and a transformation unit, according to encoding mode information of Table 1.

A LCU 1300 includes coding units 1302, 1304, 1306, 1312, 1314, 1316, and 1318 of depths. Here, since the coding unit 1318 is a coding unit of a depth, splitting information may be set to 0. Information about a partition mode of the coding unit 1318 having a size of 2N×2N may be set to be one of a partition mode 1322 having a size of 2N×2N, a partition mode 1324 having a size of 2N×N, a partition mode 1326 having a size of N×2N, a partition mode 1328 having a size of N×N, a partition mode 1332 having a size of 2N×nU, a partition mode 1334 having a size of 2N×nD, a partition mode 1336 having a size of nL×2N, and a partition mode 1338 having a size of nR×2N.

Splitting information (TU size flag) of a transformation unit is a type of a transformation index. The size of the transformation unit corresponding to the transformation index may be changed according to a prediction unit type or partition mode of the coding unit.

For example, when the partition mode is set to be symmetrical, i.e. the partition mode 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition mode is set to be asymmetrical, i.e., the partition mode 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 27, the TU size flag is a flag having a value or 0 or 1, but the TU size flag is not limited to 1 bit, and a transformation unit may be hierarchically split having a tree structure while the TU size flag increases from 0. Splitting information (TU size flag) of a transformation unit may be an example of a transformation index.

In this case, the size of a transformation unit that has been actually used may be expressed by using a TU size flag of a transformation unit, according to one or more embodiments, together with a maximum size and minimum size of the transformation unit. The video encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 may decode video by using the maximum transformation unit size information, the minimum transformation unit size information, and the maximum TU size flag.

For example, (a) if the size of a current coding unit is 64×64 and a maximum transformation unit size is 32×32, (a−1) then the size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize 32 max(MinTransformSize,RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to one or more embodiments, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the embodiments are not limited thereto.

According to the video encoding method based on coding units having a tree structure as described with reference to FIGS. 15 through 27, image data of the space domain is encoded for each coding unit of a tree structure. According to the video decoding method based on coding units having a tree structure, decoding is performed for each LCU to reconstruct image data of the space domain. Thus, a picture and a video that is a picture sequence may be reconstructed. The reconstructed video may be reproduced by a reproducing apparatus, stored in a storage medium, or transmitted through a network.

Also, SAO parameters may be signaled with respect to each picture, each slice, each LCU, each of coding units having a tree structure, each prediction unit of the coding units, or each transformation unit of the coding units. For example, pixel values of reconstructed pixels of each LCU may be adjusted by using offset values reconstructed based on received SAO parameters, and thus an LCU having a minimized error between an original block and the LCU may be reconstructed.

For convenience of description, the video encoding method according to adjustment of a sample offset, which is described above with reference to FIGS. 1A through 18, will be referred to as a ‘video encoding method according to the one or more embodiments’. In addition, the video decoding method according to adjustment of a sample offset, which is described above with reference to FIGS. 1A through 18, will be referred to as a ‘video decoding method according to the one or more embodiments’.

Also, a video encoding apparatus including the SAO encoding apparatus 10, the video encoding apparatus 100, or the image encoder 400, which is described above with reference to FIGS. 1A through 18, will be referred to as a ‘video encoding apparatus according to the one or more embodiments’. In addition, a video decoding apparatus including the SAO decoding apparatus 20, the video decoding apparatus 200, or the image decoder 500, which is described above with reference to FIGS. 1A through 18, will be referred to as a ‘video decoding apparatus according to the one or more embodiments’.

A computer-readable recording medium storing a program, e.g., a disc 26000, according to one or more embodiments will now be described in detail.

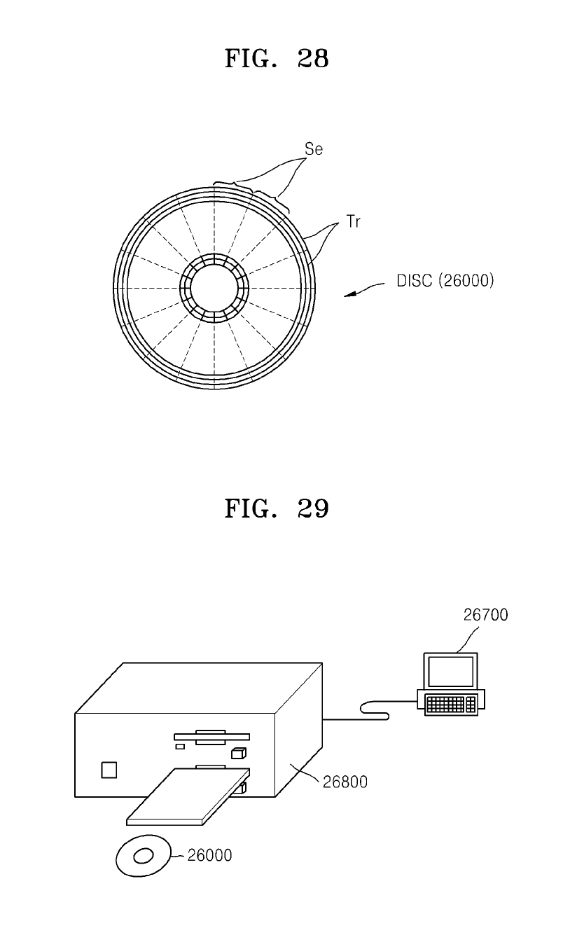

FIG. 28 is a diagram of a physical structure of the disc 26000 in which a program is stored, according to one or more embodiments. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantization parameter determination method, the video encoding method, and the video decoding method described above may be assigned and stored.

A computer system embodied using a storage medium that stores a program for executing the video encoding method and the video decoding method as described above will now be described with reference to FIG. 29.

FIG. 29 is a diagram of a disc drive 26800 for recording and reading a program by using the disc 26000. A computer system 26700 may store a program that executes at least one of a video encoding method and a video decoding method according to one or more embodiments, in the disc 26000 via the disc drive 26800. To run the program stored in the disc 26000 in the computer system 26700, the program may be read from the disc 26000 and be transmitted to the computer system 26700 by using the disc drive 26700.

The program that executes at least one of a video encoding method and a video decoding method according to one or more embodiments may be stored not only in the disc 26000 illustrated in FIG. 28 or 29 but also in a memory card, a ROM cassette, or a solid state drive (SSD).

A system to which the video encoding method and a video decoding method described above are applied will be described below.

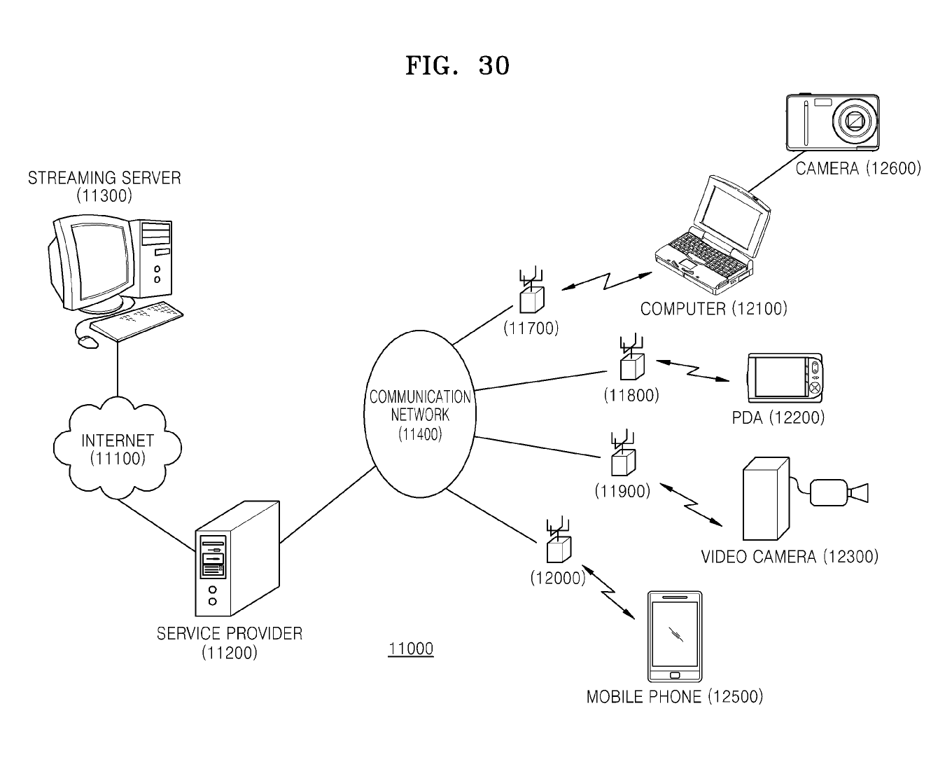

FIG. 30 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

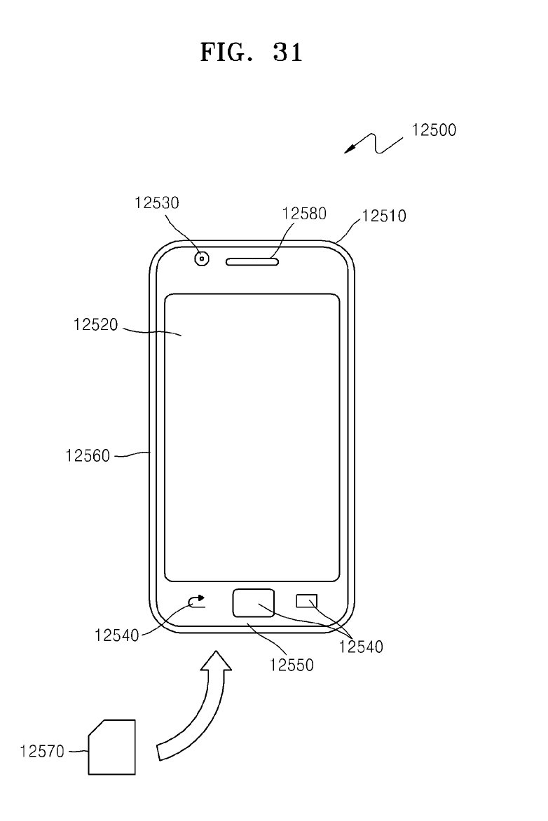

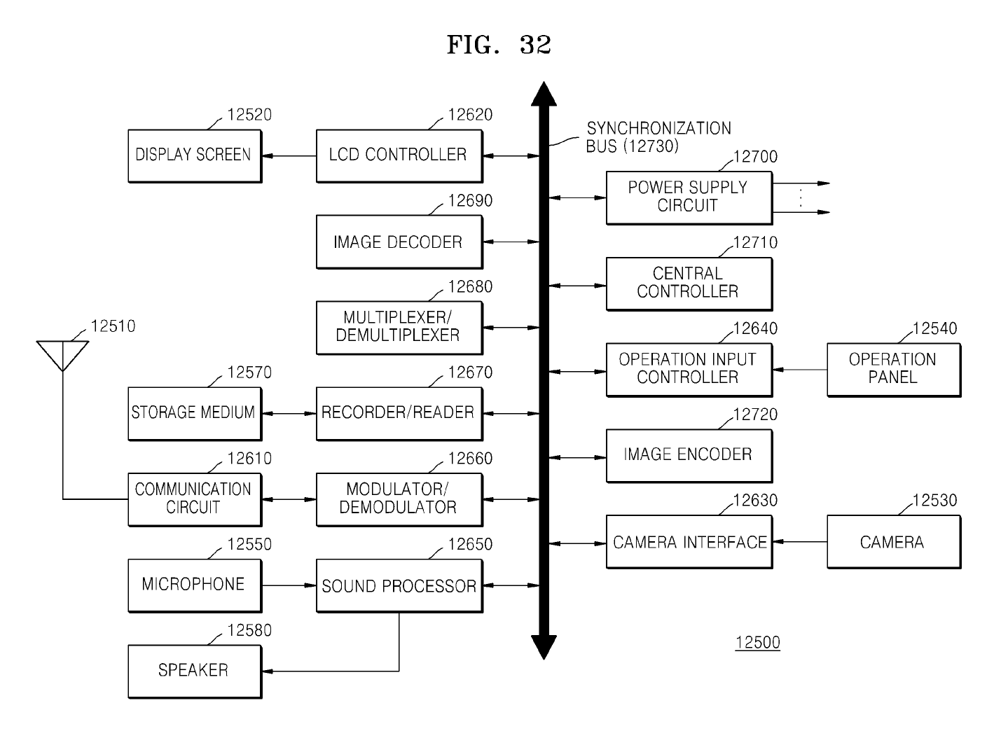

However, the content supply system 11000 is not limited to as illustrated in FIG. 31, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus according to one or more embodiments.

The mobile phone 12500 included in the content supply system 11000 according to one or more embodiments will now be described in greater detail with referring to FIGS. 31 and 32.

FIG. 31 illustrates an external structure of the mobile phone 12500 to which a video encoding method and a video decoding method are applied, according to one or more embodiments. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound outputter, and a microphone 12550 for inputting voice and sound or another type sound inputter. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 32 illustrates an internal structure of the mobile phone 12500, according to one or more embodiments. To systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recorder/reader 12670, a modulator/demodulator 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoder 12720 may generate a digital image signal, and text data of a message may be generated via the operation panel 12540 and the operation input controller 12640. When a digital signal is transmitted to the modulator/demodulator 12660 under control of the central controller 12710, the modulator/demodulator 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulator/demodulator 12660 and the communication circuit 12610, and may be transmitted via the antenna 12510.

When a text message, e.g., email, is transmitted in a data communication mode, text data of the text message is input via the operation panel 12540 and is transmitted to the central controller 12710 via the operation input controller 12640. Under control of the central controller 12710, the text data is transformed into a transmission signal via the modulator/demodulator 12660 and the communication circuit 12610 and is transmitted to the wireless base station 12000 via the antenna 12510.

To transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the above-described video encoding method according to the one or more embodiments. The image encoder 12720 may transform the image data received from the camera 12530 into compressed and encoded image data based on the above-described video encoding method according to the one or more embodiments, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulator/demodulator 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulator/demodulator 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulator/demodulator 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulator/demodulator 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoder 12690 may correspond to that of the above-described video decoding method according to the one or more embodiments. The image decoder 12690 may decode the encoded video data to obtain reconstructed video data and provide the reconstructed video data to the display screen 12520 via the LCD controller 12620, by using the above-described video decoding method according to the one or more embodiments.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to one or more embodiments, may be a transceiving terminal including only the video encoding apparatus, or may be a transceiving terminal including only the video decoding apparatus.

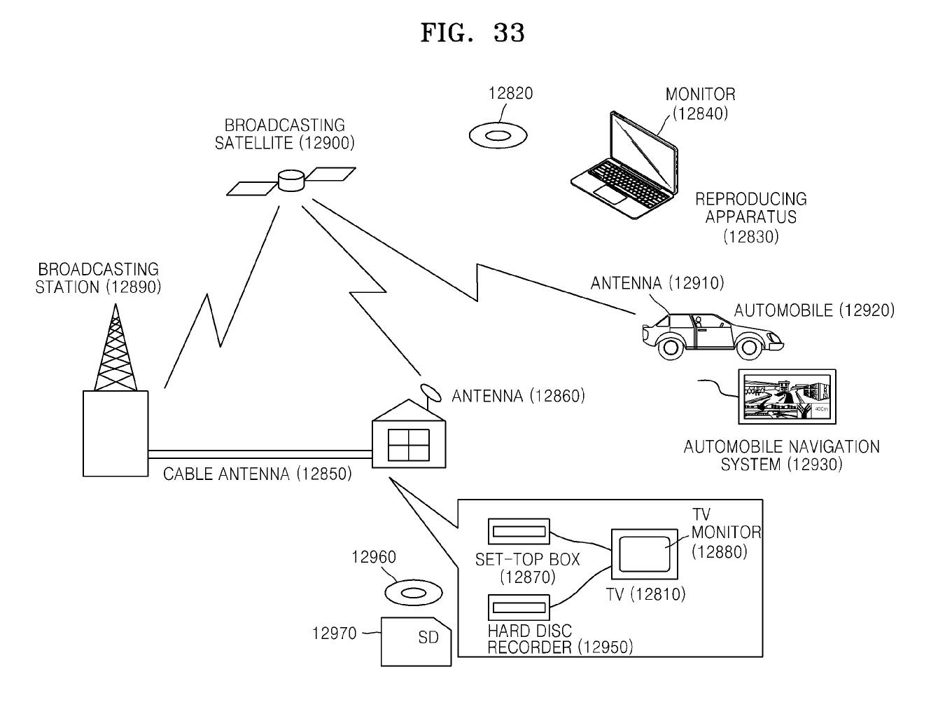

A communication system according to the one or more embodiments is not limited to the communication system described above with reference to FIG. 31. For example, FIG. 33 illustrates a digital broadcasting system employing a communication system, according to one or more embodiments. The digital broadcasting system of FIG. 33 may receive a digital broadcast transmitted via a satellite or a terrestrial network by using a video encoding apparatus and a video decoding apparatus according to one or more embodiments.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to one or more embodiments is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to one or more embodiments may be installed. Data output from the set-top box 12870 may also be reproduced on a TV monitor 12880.

As another example, a video decoding apparatus according to one or more embodiments may be installed in the TV receiver 12810 instead of the set-top box 12870.

An automobile 12920 that has an appropriate antenna 12910 may receive a signal transmitted from the satellite 12900 or the wireless base station 11700 of FIG. 21. A decoded video may be reproduced on a display screen of an automobile navigation system 12930 installed in the automobile 12920.

A video signal may be encoded by a video encoding apparatus according to one or more embodiments and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus according to one or more embodiments, a video signal recorded on the DVD disc 12960, the SD card 12970, or another storage medium may be reproduced on the TV monitor 12880.

The automobile navigation system 12930 may not include the camera 12530 of FIG. 32, and the camera interface 12630 and the image encoder 12720 of FIG. 32. For example, the computer 12100 and the TV receiver 12810 may not include the camera 12530, the camera interface 12630, and the image encoder 12720.

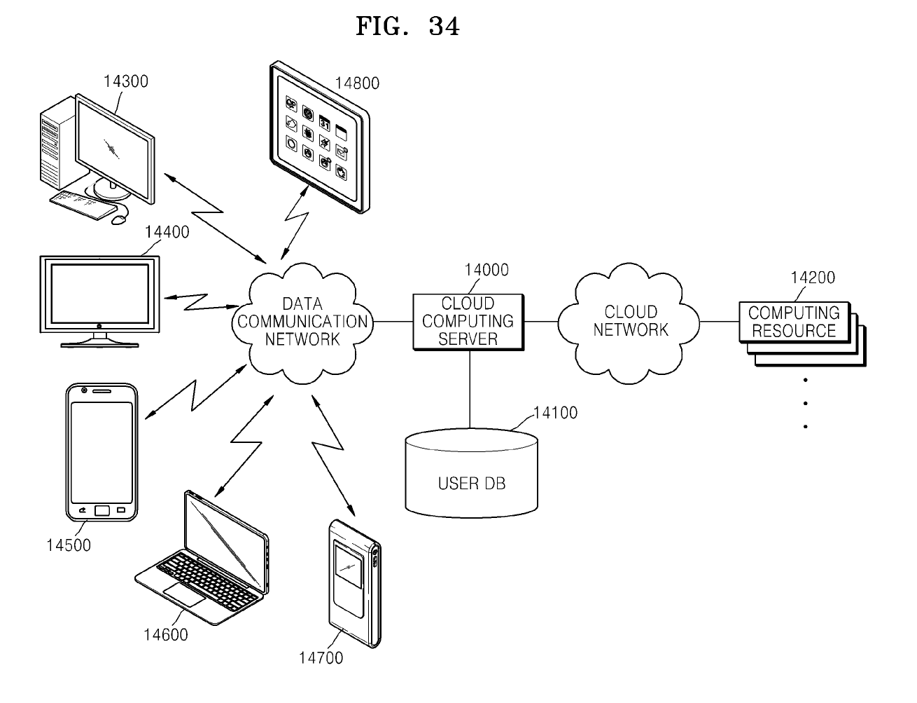

FIG. 34 is a diagram illustrating a network structure of a cloud computing system using a video encoding apparatus and a video decoding apparatus, according to one or more embodiments.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 31.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include a video decoding apparatus as described above with reference to FIGS. 1A through 27. As another example, the user terminal may include a video encoding apparatus as described above with reference to FIGS. 1A through 27. Alternatively, the user terminal may include both the video decoding apparatus and the video encoding apparatus as described above with reference to FIGS. 1A through 27.

Various applications of a video encoding method, a video decoding method, a video encoding apparatus, and a video decoding apparatus according to the one or more embodiments described above with reference to FIGS. 1A through 27 have been described above with reference to FIGS. 28 to 34. However, methods of storing the video encoding method and the video decoding method in a storage medium or methods of implementing the video encoding apparatus and the video decoding apparatus in a device, according to various embodiments, are not limited to the embodiments described above with reference to FIGS. 28 to 34.

As used herein, a technique “A may include one of a1, a2 and a3” is that an element A may include an exemplary element a1, a2, or a3 in a wide sense.

Due to the above-described technique, an element that may be included the element A is not necessarily limited to a1, a2 or a3. Thus, the technique is not exclusively construed that an element that may be included in A excludes other elements that are not exemplified, in addition to a1, a2, and a3.

Further, the technique means that A may include a1, a2, or a3. The technique does not mean that elements included in A are not necessarily selectively determined within a predetermined set. For example, the technique is not limited to construe that a1, a2, or a3 selected from a set including a1, a2, and a3 is necessarily included in the component A.

In addition, in the present specification, a technique “at least one of a1, a2, or (and) a3f” means one of a1; a2; a3; a1 and a2; a1 and a3; a2 and a3; and a1 and a2, and a3.

Thus, unless explicitly described as “at least one of a1, at least one of a2, or (and) at least one of a3”, the technique “at least one of a1, a2, or (and) a3” is not construed as “at least one of a1, at least one of a2, or (and) at least one of a3”.

The embodiments may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

It should be understood that the exemplary embodiments described therein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A video encoding method of signaling a sample adaptive offset (SAO) parameter, the video encoding method comprising:
from among largest coding units (LCUs) of a video, obtaining prediction information before de-blocking of a currently encoded LCU is performed;
predicting an SAO parameter of the currently encoded LCU based on the obtained prediction information; and
performing entropy encoding on the predicted SAO parameter.

2. The video encoding method of claim 1, wherein the predicting the SAO parameter of the currently encoded LCU is independent from the de-blocking of the currently encoded LCU.

3. The video encoding method of claim 1, wherein the obtaining the prediction information comprises: obtaining an SAO parameter of another encoded coding unit before performing the de-blocking of the currently encoded LCU.

4. The video encoding method of claim 3, wherein the prediction information comprises an SAO parameter of a previously encoded LCU within a frame including the currently encoded LCU.

5. The video encoding method of claim 3, wherein the prediction information comprises an SAO parameter of an encoded LCU of a frame previous to a frame including the currently encoded LCU.

6. The video encoding method of claim 1, wherein the obtaining the prediction information comprises obtaining a reconstructed pixel value before performing the de-blocking of the currently encoded LCU, and
wherein the predicting the SAO parameter comprises: predicting the SAO parameter of the currently encoded LCU based on the pixel value.

7. The video encoding method of claim 1, wherein the prediction information comprises at least one of residue data, a motion vector, and an intra mode that are obtained before the currently encoded LCU is reconstructed.

8. The video encoding method of claim 1, further comprising:
performing de-blocking on the currently encoded LCU; and
determining an SAO parameter by using the currently encoded LCU on which the de-blocking is performed,
wherein the SAO parameter determined with respect to the currently encoded LCU on which the de-blocking is performed is used to perform SAO prediction on a subsequently encoded LCU.

9. The video encoding method of claim 8, wherein the video encoding method is performed in a stage unit having a pipeline structure, and
wherein the performing the de-blocking and the performing of entropy encoding on the predicted SAO parameter are in parallel performed on the same pipeline stage.

10. A video encoding method of signaling an SAO parameter, the video encoding method comprising:
obtaining directionality information of a currently encoded largest coding unit (LCU) of a video;
determining an edge offset parameter of the currently encoded LCU based on the obtained directionality information; and
performing entropy encoding on the determined edge offset parameter.

11. The video encoding method of claim 10, wherein the determining the edge offset parameter comprises determining an edge class having directionality that is the same as or is orthogonal to a direction obtained based on the directionality information as the edge offset parameter.

12. The video encoding method of claim 10, wherein the obtaining of the directionality information comprises: obtaining directionality information of an edge of the currently encoded LCU by using a predetermined edge algorithm.

13. The video encoding method of claim 10, wherein the obtaining the directionality information comprises obtaining the directionality information by using intra mode information of the currently encoded LCU.

14. The video encoding method of claim 13, wherein the obtaining the directionality information comprises: in response to intra modes of prediction units included in the currently encoded LCU being different from each other, calculating a histogram regarding the intra modes of the prediction units and obtaining the directionality information based on a number of occurrences of the intra modes from the histogram.

15. The video encoding method of claim 10, wherein the obtaining the directionality information comprises obtaining the directionality information based on a motion vector of the currently encoded LCU.

16. A video encoding apparatus for signaling an SAO parameter, the video encoding apparatus comprising:
a prediction information predictor configured to obtain, from among largest coding units (LCUs) of a video, prediction information before de-blocking of a currently encoded LCU is performed;
an SAO parameter estimator configured to predict an SAO parameter of the currently encoded LCU based on the obtained prediction information; and
an encoder configured to perform entropy encoding on the predicted SAO parameter.

17. The video encoding apparatus of claim 16, wherein the prediction information predictor obtains an SAO parameter of another encoded coding unit before the de-blocking of the currently encoded LCU is performed.

18. The video encoding apparatus of claim 16, wherein the prediction information comprises at least one of a pixel value of a current LCU, residue data, a motion vector, and an intra mode that are reconstructed before the de-blocking of the currently encoded LCU is performed.

19. The video encoding apparatus of claim 16, further comprising:
a de-blocker configured to perform de-blocking on a currently encoded LCU; and
an SAO determiner configured to determine an SAO parameter by using the currently encoded LCU on which de-blocking is performed,
wherein the SAO parameter determined with respect to the currently encoded LCU on which de-blocking is performed is used to perform SAO prediction on a subsequently encoded LCU.

20. A video encoding apparatus for signaling an SAO parameter, the video encoding apparatus comprising:
a directionality information obtainer configured to obtain directionality information of a currently encoded LCU of a video;
an edge offset parameter determiner configured to determine an edge offset parameter of the currently encoded LCU based on the obtained directionality information; and
an encoder configured to perform entropy encoding on the determined edge offset parameter.

21. The video encoding apparatus of claim 20, wherein the edge offset parameter determiner determines an edge class having directionality that is the same as or is orthogonal to a direction obtained based on the directionality information as the edge offset parameter.

22. The video encoding apparatus of claim 20, wherein the directionality information obtainer obtains directionality information of an edge of the currently encoded LCU by using a predetermined edge algorithm.

23. The video encoding apparatus of claim 20, wherein the directionality information obtainer obtains the directionality information by using intra mode information of the currently encoded LCU.

24. The video encoding apparatus of claim 20, wherein in response to intra modes of prediction units included in the currently encoded LCU being different from each other, the directionality information obtainer calculates a histogram regarding the intra modes of the prediction units and obtains the directionality information based on a number of occurrences of the intra modes from the histogram.

25. The video encoding apparatus of claim 20, wherein the directionality information obtainer obtains the directionality information based on a motion vector of the currently encoded LCU.

26. A non-transitory computer-readable recording medium having recorded thereon a computer program for executing the method of claim 1.
